(19) United States
(12) Patent Application Publication
(10) Pub. No.: US 2025/0294425 A1
(43) Pub. Date: Sep. 18, 2025

(54) METHOD AND APPARATUS FOR MOBILITY BASED ON HEIGHT IN A WIRELESS COMMUNICATION SYSTEM

(71) Applicant: LG ELECTRONICS INC., Seoul (KR)

(72) Inventors: Myoungsoo KIM, Seoul (KR); Sunghoon JUNG, Seoul (KR); Hongsuk KIM, Seoul (KR)

(73) Assignee: LG ELECTRONICS INC., Seoul (KR)

(21) Appl. No.: 18/858,676

(22) PCT Filed: Apr. 28, 2023
(86) PCT No.: PCT/KR2023/005840

§ 371 Date: Oct. 21, 2024

Related U.S. Application Data
(60) Provisional application No. 63/337,180, filed on May 2, 2022.

(51) Int. Cl. H04W 36/32; H04W 36/36

(52) U.S. Cl. CPC H04W 36/328; H04W 36/362

(57) ABSTRACT

A method and apparatus for mobility based on height in a wireless communication system is provided. A wireless device receives information on a mobility configuration associated with a height range; monitoring a current height of the wireless device. A wireless device evaluates at least one condition for a mobility based on the mobility configuration, based on the current height of the wireless device being in the height range. A wireless device performs mobility to a target cell among one or more candidate target cells based on the evaluation. The mobility configuration includes information on the one or more candidate target cells.

### CROSS-REFERENCE TO RELATED APPLICATIONS

This application is the National Stage filing under 35 U.S.C. 371 of International Application No. PCT/KR2023/005840, filed on Apr. 28, 2023, which claims the benefit of U.S. Provisional Application No. 63/337,180, filed on May 2, 2022, the contents of which are all hereby incorporated by reference herein in their entireties.

### TECHNICAL FIELD

The present disclosure relates to a method and apparatus for mobility based on height in a wireless communication system.

### BACKGROUND

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in international telecommunication union (ITU) and 3GPP to develop requirements and specifications for new radio (NR) systems. 3GPP has to identify and develop the technology components needed for successfully standardizing the new RAT timely satisfying both the urgent market needs, and the more long-term requirements set forth by the ITU radio communication sector (ITU-R) international mobile telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced mobile broadband (eMBB), massive machine-type-communications (mMTC), ultra-reliable and low latency communications (URLLC), etc. The NR shall be inherently forward compatible.

### SUMMARY

As the altitude of aerial UEs increases, they experience a line-of-sight propagation condition to more cells, resulting in faraway cells becoming more visible to them. Consequently, aerial UEs will receive interference from more cells in the downlink and cause interference to more cells in the uplink. Additionally, the aerial coverage becomes fragmented at higher altitudes. Typically, terrestrial UEs are served by the closest network as the main lobe points towards the ground. In contrast, aerial UEs are served by a side lobe of a neighbor network located far from the aerial UE. Therefore, the faraway network can become the serving network, and the cell coverage may not be continuous.

As aerial UEs fly across multiple cells at a particular height and direction, the quality of their serving cell fluctuates with a certain frequency based on network evaluation. Aerial UEs can see multiple cells with similar signal strength, making it difficult to select a suitable cell based on cell quality alone, such as RSRP and RSRQ. Especially in the case of conditional mobility, such as a conditional handover (CHO) and a Conditional PSCell Addition/Change (CPAC), if the aerial UE detects more neighbor cells, the UE may execute cell change more frequently. This causes more signaling overhead in the air interference, and the network may perform more handover preparation of neighbor cells for CHO/CPAC.

Therefore, studies for mobility based on height in a wireless communication system are required.

In an aspect, a method performed by a wireless device in a wireless communication system is provided. The method comprises: receiving information on a mobility configuration associated with a height range: monitoring a current height of the wireless device: evaluating at least one condition for a mobility based on the mobility configuration, based on the current height of the wireless device being in the height range; and performing mobility to a target cell among one or more candidate target cells based on the evaluation, wherein the mobility configuration includes information on the one or more candidate target cells.

In another aspect, an apparatus for implementing the above method is provided.

The present disclosure can have various advantageous effects.

According to some embodiments of the present disclosure, a wireless device could efficiently perform conditional mobility based on the height-based mobility configuration.

For example, depending on its altitude, the UE may perform a reselection of or execute conditional mobility to a suitable cell, such as a UAV-specific cell or a nearby cell.

In other words, the UE may reselect or execute conditional mobility to a suitable cell, such as a UAV specific cell or a nearby cell, according to the height.

For example, by applying candidate target cells based on the height of the wireless device, it can perform efficient mobility such as CHO and/or CPAC.

For example, a wireless device could save resources by preventing mobility to unsuitable cells.

According to some embodiments of the present disclosure, a wireless network system could provide an efficient solution for the height-based mobility.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF THE DRAWINGS

FIG. 1 shows an example of a communication system to which implementations of the present disclosure is applied.

FIG. 2 shows an example of wireless devices to which implementations of the present disclosure is applied.

FIG. 3 shows an example of a wireless device to which implementations of the present disclosure is applied.

FIG. 4 shows another example of wireless devices to which implementations of the present disclosure is applied.

FIG. 5 shows an example of UE to which implementations of the present disclosure is applied.

FIGS. 6 and 7 show an example of protocol stacks in a 3GPP based wireless communication system to which implementations of the present disclosure is applied.

FIG. 8 shows a frame structure in a 3GPP based wireless communication system to which implementations of the present disclosure is applied.

FIG. 9 shows a data flow example in the 3GPP NR system to which implementations of the present disclosure is applied.

FIG. 10 shows an example of a method for mobility based on height in a wireless communication system, according to some embodiments of the present disclosure.

FIG. 11 shows an example of a method for a mobility based on height procedure in a wireless communication system, according to some embodiments of the present disclosure.

FIG. 12 shows an example of a method for a mobility based on height procedure in a wireless communication system, according to some embodiments of the present disclosure.

FIG. 13 shows an example of a method for a mobility based on height procedure in a wireless communication system, according to some embodiments of the present disclosure.

FIG. 14 shows an example of a method for a mobility based on height procedure in a wireless communication system, according to some embodiments of the present disclosure.

FIG. 15 shows an example of a method for a mobility based on height procedure in a wireless communication system, according to some embodiments of the present disclosure.

FIG. 16 shows an example of a method for a mobility based on height procedure in a wireless communication system, according to some embodiments of the present disclosure.

FIG. 17 shows an example of a method for a mobility based on height procedure in a wireless communication system, according to some embodiments of the present disclosure.

FIG. 18 shows an example of a method for a mobility based on height procedure in a wireless communication system, according to some embodiments of the present disclosure.

FIG. 19 shows an example of a method for a mobility based on height procedure in a wireless communication system, according to some embodiments of the present disclosure.

FIG. 20 shows an example of a method for a mobility based on height procedure in a wireless communication system, according to some embodiments of the present disclosure.

FIG. 21 shows an example of a method for a mobility based on height procedure in a wireless communication system, according to some embodiments of the present disclosure.

FIG. 22 shows an example of a method for a mobility based on height procedure in a wireless communication system, according to some embodiments of the present disclosure.

FIG. 23 shows an example of a method for a mobility based on height procedure in a wireless communication system, according to some embodiments of the present disclosure.

FIG. 24 shows an example of a method for a mobility based on height procedure in a wireless communication system, according to some embodiments of the present disclosure.

FIG. 25 shows an example of a method for a mobility based on height procedure in a wireless communication system, according to some embodiments of the present disclosure.

FIG. 26 shows an example of a method for a mobility based on height procedure in a wireless communication system, according to some embodiments of the present disclosure.

FIG. 27 shows an example of a method for a mobility based on height procedure in a wireless communication system, according to some embodiments of the present disclosure.

FIG. 28 shows an example of a method for a mobility based on height procedure in a wireless communication system, according to some embodiments of the present disclosure.

FIG. 29 shows an example of a method for a mobility based on height procedure in a wireless communication system, according to some embodiments of the present disclosure.

FIG. 30 shows an example of a method for a mobility based on height procedure in a wireless communication system, according to some embodiments of the present disclosure.

FIG. 31 shows an example of a method for a mobility based on height procedure in a wireless communication system, according to some embodiments of the present disclosure.

FIG. 32 shows an example of a method for a mobility based on height procedure in a wireless communication system, according to some embodiments of the present disclosure.

FIG. 33 shows an example of a method for a mobility based on height procedure in a wireless communication system, according to some embodiments of the present disclosure.

FIG. 34 shows an example of a method for a mobility based on height procedure in a wireless communication system, according to some embodiments of the present disclosure.

FIG. 35 shows an example of a method for a mobility based on height procedure in a wireless communication system, according to some embodiments of the present disclosure.

FIG. 36 shows an example of a method for a mobility based on height procedure in a wireless communication system, according to some embodiments of the present disclosure.

FIG. 37 shows an example of a method for a mobility based on height procedure in a wireless communication system, according to some embodiments of the present disclosure.

### DETAILED DESCRIPTION

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi). IEEE 802.16 (WiMAX). IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. LTE-advanced (LTE-A) is an evolved version of 3GPP LTE.

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

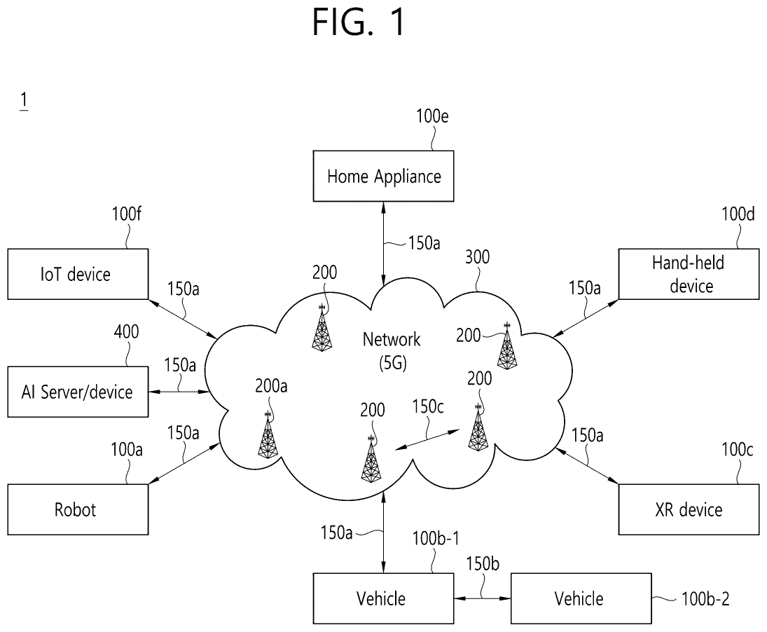

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced mobile broadband (eMBB), (2) a category of massive machine type communication (mMTC), and (3) a category of ultra-reliable and low latency communications (URLLC).

Partial use cases may require a plurality of categories for optimization and other use cases may focus only upon one key performance indicator (KPI). 5G supports such various use cases using a flexible and reliable method.

eMBB far surpasses basic mobile Internet access and covers abundant bidirectional work and media and entertainment applications in cloud and augmented reality. Data is one of 5G core motive forces and, in a 5G era, a dedicated voice service may not be provided for the first time. In 5G, it is expected that voice will be simply processed as an application program using data connection provided by a communication system. Main causes for increased traffic volume are due to an increase in the size of content and an increase in the number of applications requiring high data transmission rate. A streaming service (of audio and video), conversational video, and mobile Internet access will be more widely used as more devices are connected to the Internet. These many application programs require connectivity of an always turned-on state in order to push real-time information and alarm for users. Cloud storage and applications are rapidly increasing in a mobile communication platform and may be applied to both work and entertainment. The cloud storage is a special use case which accelerates growth of uplink data transmission rate. 5G is also used for remote work of cloud. When a tactile interface is used, 5G demands much lower end-to-end latency to maintain user good experience. Entertainment, for example, cloud gaming and video streaming, is another core element which increases demand for mobile broadband capability. Entertainment is essential for a smartphone and a tablet in any place including high mobility environments such as a train, a vehicle, and an airplane. Other use cases are augmented reality for entertainment and information search. In this case, the augmented reality requires very low latency and instantaneous data volume.

In addition, one of the most expected 5G use cases relates a function capable of smoothly connecting embedded sensors in all fields, i.e., mMTC. It is expected that the number of potential Internet-of-things (IoT) devices will reach 204 hundred million up to the year of 2020. An industrial IoT is one of categories of performing a main role enabling a smart city, asset tracking, smart utility, agriculture, and security infrastructure through 5G.

URLLC includes a new service that will change industry through remote control of main infrastructure and an ultra-reliable/available low-latency link such as a self-driving vehicle. A level of reliability and latency is essential to control a smart grid, automatize industry, achieve robotics, and control and adjust a drone.

5G is a means of providing streaming evaluated as a few hundred megabits per second to gigabits per second and may complement fiber-to-the-home (FTTH) and cable-based broadband (or DOCSIS). Such fast speed is needed to deliver TV in resolution of 4K or more (6K. 8K, and more), as well as virtual reality and augmented reality. Virtual reality (VR) and augmented reality (AR) applications include almost immersive sports games. A specific application program may require a special network configuration. For example, for VR games, gaming companies need to incorporate a core server into an edge network server of a network operator in order to minimize latency.

Automotive is expected to be a new important motivated force in 5G together with many use cases for mobile communication for vehicles. For example, entertainment for passengers requires high simultaneous capacity and mobile broadband with high mobility. This is because future users continue to expect connection of high quality regardless of their locations and speeds. Another use case of an automotive field is an AR dashboard. The AR dashboard causes a driver to identify an object in the dark in addition to an object seen from a front window and displays a distance from the object and a movement of the object by overlapping information talking to the driver. In the future, a wireless module enables communication between vehicles, information exchange between a vehicle and supporting infrastructure, and information exchange between a vehicle and other connected devices (e.g., devices accompanied by a pedestrian). A safety system guides alternative courses of a behavior so that a driver may drive more safely drive, thereby lowering the danger of an accident. The next stage will be a remotely controlled or self-driven vehicle. This requires very high reliability and very fast communication between different self-driven vehicles and between a vehicle and infrastructure. In the future, a self-driven vehicle will perform all driving activities and a driver will focus only upon abnormal traffic that the vehicle cannot identify. Technical requirements of a self-driven vehicle demand ultra-low latency and ultra-high reliability so that traffic safety is increased to a level that cannot be achieved by human being.

A smart city and a smart home/building mentioned as a smart society will be embedded in a high-density wireless sensor network. A distributed network of an intelligent sensor will identify conditions for costs and energy-efficient maintenance of a city or a home. Similar configurations may be performed for respective households. All of temperature sensors, window and heating controllers, burglar alarms, and home appliances are wirelessly connected. Many of these sensors are typically low in data transmission rate, power, and cost. However, real-time HD video may be demanded by a specific type of device to perform monitoring.

Consumption and distribution of energy including heat or gas is distributed at a higher level so that automated control of the distribution sensor network is demanded. The smart grid collects information and connects the sensors to each other using digital information and communication technology so as to act according to the collected information. Since this information may include behaviors of a supply company and a consumer, the smart grid may improve distribution of fuels such as electricity by a method having efficiency, reliability, economic feasibility, production sustainability, and automation. The smart grid may also be regarded as another sensor network having low latency.

Mission critical application (e.g., e-health) is one of 5G use scenarios. A health part contains many application programs capable of enjoying benefit of mobile communication. A communication system may support remote treatment that provides clinical treatment in a faraway place. Remote treatment may aid in reducing a barrier against distance and improve access to medical services that cannot be continuously available in a faraway rural area. Remote treatment is also used to perform important treatment and save lives in an emergency situation. The wireless sensor network based on mobile communication may provide remote monitoring and sensors for parameters such as heart rate and blood pressure.

Wireless and mobile communication gradually becomes important in the field of an industrial application. Wiring is high in installation and maintenance cost. Therefore, a possibility of replacing a cable with reconstructible wireless links is an attractive opportunity in many industrial fields. However, in order to achieve this replacement, it is necessary for wireless connection to be established with latency, reliability, and capacity similar to those of the cable and management of wireless connection needs to be simplified. Low latency and a very low error probability are new requirements when connection to 5G is needed.

Logistics and freight tracking are important use cases for mobile communication that enables inventory and package tracking anywhere using a location-based information system. The use cases of logistics and freight typically demand low data rate but require location information with a wide range and reliability.

Referring to FIG. 1, the communication system 1 includes wireless devices 100a to 100f, base stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using radio access technology (RAT) (e.g., 5G new RAT (NR)) or LTE) and may be referred to as communication/radio/5G devices. The wireless devices 100a to 100f may include, without being limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of performing communication between vehicles. The vehicles may include an unmanned aerial vehicle (UAV) (e.g., a drone). The XR device may include an AR/VR/Mixed Reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called user equipments (UEs). A UE may include, for example, a cellular phone, a smartphone, a laptop computer, a digital broadcast terminal, a personal digital assistant (PDA), a portable multimedia player (PMP), a navigation system, a slate personal computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The UAV may be, for example, an aircraft aviated by a wireless control signal without a human being onboard.

The VR device may include, for example, a device for implementing an object or a background of the virtual world. The AR device may include, for example, a device implemented by connecting an object or a background of the virtual world to an object or a background of the real world. The MR device may include, for example, a device implemented by merging an object or a background of the virtual world into an object or a background of the real world. The hologram device may include, for example, a device for implementing a stereoscopic image of 360 degrees by recording and reproducing stereoscopic information, using an interference phenomenon of light generated when two laser lights called holography meet.

The public safety device may include, for example, an image relay device or an image device that is wearable on the body of a user.

The MTC device and the IoT device may be, for example, devices that do not require direct human intervention or manipulation. For example, the MTC device and the IoT device may include smartmeters, vending machines, thermometers, smartbulbs, door locks, or various sensors.

The medical device may be, for example, a device used for the purpose of diagnosing, treating, relieving, curing, or preventing disease. For example, the medical device may be a device used for the purpose of diagnosing, treating, relieving, or correcting injury or impairment. For example, the medical device may be a device used for the purpose of inspecting, replacing, or modifying a structure or a function. For example, the medical device may be a device used for the purpose of adjusting pregnancy. For example, the medical device may include a device for treatment, a device for operation, a device for (in vitro) diagnosis, a hearing aid, or a device for procedure.

The security device may be, for example, a device installed to prevent a danger that may arise and to maintain safety. For example, the security device may be a camera, a closed-circuit TV (CCTV), a recorder, or a black box.

The FinTech device may be, for example, a device capable of providing a financial service such as mobile payment. For example, the FinTech device may include a payment device or a point of sales (POS) system.

The weather/environment device may include, for example, a device for monitoring or predicting a weather/environment.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., vehicle-to-vehicle (V2V)/vehicle-to-everything (V2X) communication). The IoT device (e.g., a sensor) may perform direct communication with other IoT devices (e.g., sensors) or other wireless devices 100a to 100f.

Wireless communication/connections 150a. 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or device-to-device (D2D) communication) 150b, inter-base station communication 150c (e.g., relay, integrated access and backhaul (IAB)), etc. The wireless devices 100a to 100f and the BSs 200/the wireless devices 100a to 100f may transmit/receive radio signals to/from each other through the wireless communication/connections 150a. 150b and 150c. For example, the wireless communication/connections 150a. 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

Here, the radio communication technologies implemented in the wireless devices in the present disclosure may include narrowband internet-of-things (NB-IoT) technology for low-power communication as well as LTE, NR and 6G. For example, NB-IoT technology may be an example of low power wide area network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced machine type communication (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate personal area networks (PANs) associated with small/low-power digital communication based on various specifications such as IEEE 802.15.4 and may be called various names.

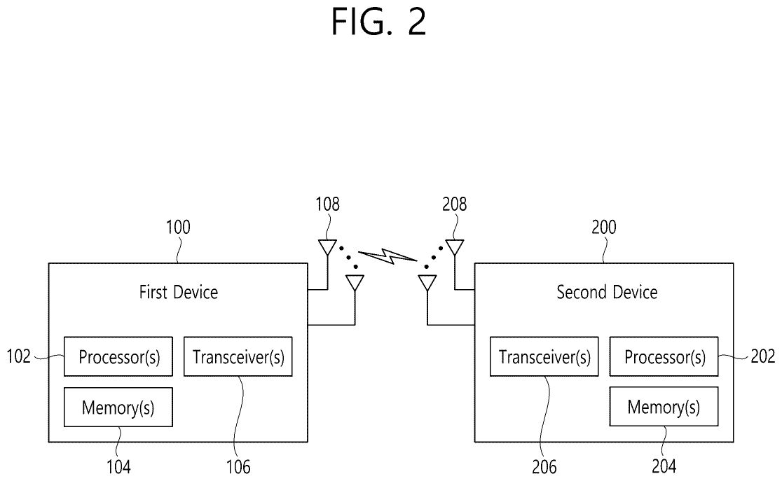

FIG. 2 shows an example of wireless devices to which implementations of the present disclosure is applied.

Referring to FIG. 2, a first wireless device 100 and a second wireless device 200 may transmit/receive radio signals to/from an external device through a variety of RATs (e.g., LTE and NR). In FIG. 2, {the first wireless device 100 and the second wireless device 200} may correspond to at least one of {the wireless device 100a to 100f and the BS 200}, {the wireless device 100a to 100f and the wireless device 100a to ′} and/or {the BS 200 and the BS 200} of FIG. 1.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, suggestions, methods and/or operational flowcharts described in the present disclosure. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver(s) 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, suggestions, methods and/or operational flowcharts described in the present disclosure. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with radio frequency (RF) unit(s). In the present disclosure, the first wireless device 100 may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, suggestions, methods and/or operational flowcharts described in the present disclosure. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, suggestions, methods and/or operational flowcharts described in the present disclosure. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as physical (PHY) layer, media access control (MAC) layer, radio link control (RLC) layer, packet data convergence protocol (PDCP) layer, radio resource control (RRC) layer, and service data adaptation protocol (SDAP) layer). The one or more processors 102 and 202 may generate one or more protocol data units (PDUs) and/or one or more service data unit (SDUs) according to the descriptions, functions, procedures, suggestions, methods and/or operational flowcharts disclosed in the present disclosure. The one or more processors 102 and 202 may generate messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202, descriptions, functions, procedures, suggestions, methods and/or operational flowcharts disclosed in the present disclosure may be implemented using firmware or software and the firmware or software may be configured to include the modules, procedures, or functions. Firmware or software configured to perform the descriptions, functions, procedures, suggestions, methods and/or operational flowcharts disclosed in the present disclosure may be included in the one or more processors 102 and 202 or stored in the one or more memories 104 and 204 so as to be driven by the one or more processors 102 and 202. The descriptions, functions, procedures, suggestions, methods and/or operational flowcharts disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas may be a plurality of physical antennas or a plurality of logical antennas (e.g., antenna ports).

The one or more transceivers 106 and 206 may convert received radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the transceivers 106 and 206 can up-convert OFDM baseband signals to a carrier frequency by their (analog) oscillators and/or filters under the control of the processors 102 and 202 and transmit the up-converted OFDM signals at the carrier frequency. The transceivers 106 and 206 may receive OFDM signals at a carrier frequency and down-convert the OFDM signals into OFDM baseband signals by their (analog) oscillators and/or filters under the control of the transceivers 102 and 202.

In the implementations of the present disclosure, a UE may operate as a transmitting device in uplink (UL) and as a receiving device in downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be configured to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be configured to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

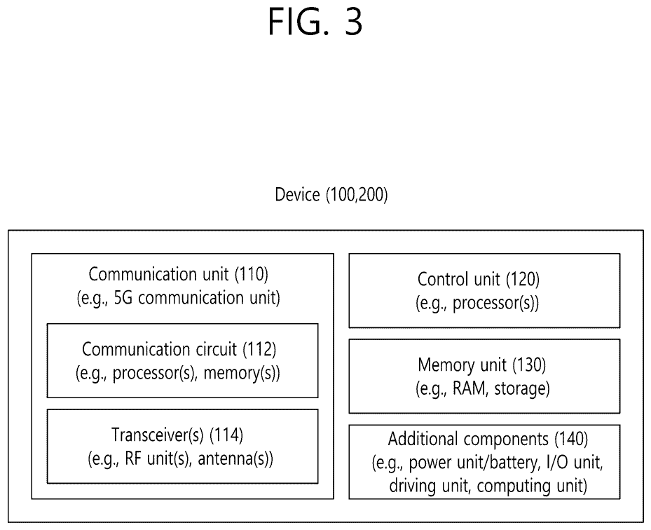

FIG. 3 shows an example of a wireless device to which implementations of the present disclosure is applied.

The wireless device may be implemented in various forms according to a use-case/service (refer to FIG. 1).

Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 of FIG. 2 and/or the one or more memories 104 and 204 of FIG. 2. For example, the transceiver(s) 114 may include the one or more transceivers 106 and 206 of FIG. 2 and/or the one or more antennas 108 and 208 of FIG. 2. The control unit 120 is electrically connected to the communication unit 110, the memory 130, and the additional components 140 and controls overall operation of each of the wireless devices 100 and 200. For example, the control unit 120 may control an electric/mechanical operation of each of the wireless devices 100 and 200 based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of the wireless devices 100 and 200. For example, the additional components 140 may include at least one of a power unit/battery, input/output (I/O) unit (e.g., audio I/O port, video I/O port), a driving unit, and a computing unit. The wireless devices 100 and 200 may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast terminal, a hologram device, a public safety device, an MTC device, a medicine device, a FinTech device (or a finance device), a security device, a climate/environment device, the AI server/device (400 of FIG. 1), the BSs (200 of FIG. 1), a network node, etc. The wireless devices 100 and 200 may be used in a mobile or fixed place according to a use-example/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor (AP), an electronic control unit (ECU), a graphical processing unit, and a memory control processor. As another example, the memory 130 may be configured by a RAM, a DRAM, a ROM, a flash memory, a volatile memory, a non-volatile memory, and/or a combination thereof.

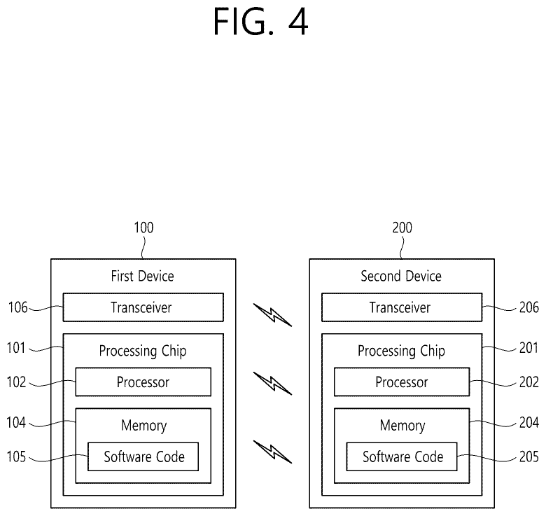

FIG. 4 shows another example of wireless devices to which implementations of the present disclosure is applied.

Referring to FIG. 4, wireless devices 100 and 200 may correspond to the wireless devices 100 and 200 of FIG. 2 and may be configured by various elements, components, units/portions, and/or modules.

The first wireless device 100 may include at least one transceiver, such as a transceiver 106, and at least one processing chip, such as a processing chip 101. The processing chip 101 may include at least one processor, such a processor 102, and at least one memory, such as a memory 104. The memory 104 may be operably connectable to the processor 102. The memory 104 may store various types of information and/or instructions. The memory 104 may store a software code 105 which implements instructions that, when executed by the processor 102, perform the descriptions, functions, procedures, suggestions, methods and/or operational flowcharts disclosed in the present disclosure. For example, the software code 105 may implement instructions that, when executed by the processor 102, perform the descriptions, functions, procedures, suggestions, methods and/or operational flowcharts disclosed in the present disclosure. For example, the software code 105 may control the processor 102 to perform one or more protocols. For example, the software code 105 may control the processor 102 may perform one or more layers of the radio interface protocol.

The second wireless device 200 may include at least one transceiver, such as a transceiver 206, and at least one processing chip, such as a processing chip 201. The processing chip 201 may include at least one processor, such a processor 202, and at least one memory, such as a memory 204. The memory 204 may be operably connectable to the processor 202. The memory 204 may store various types of information and/or instructions. The memory 204 may store a software code 205 which implements instructions that, when executed by the processor 202, perform the descriptions, functions, procedures, suggestions, methods and/or operational flowcharts disclosed in the present disclosure. For example, the software code 205 may implement instructions that, when executed by the processor 202, perform the descriptions, functions, procedures, suggestions, methods and/or operational flowcharts disclosed in the present disclosure. For example, the software code 205 may control the processor 202 to perform one or more protocols. For example, the software code 205 may control the processor 202 may perform one or more layers of the radio interface protocol.

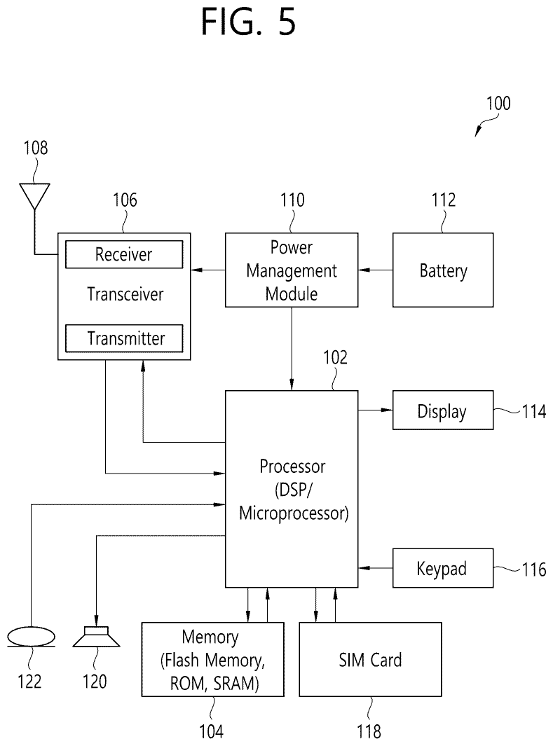

FIG. 5 shows an example of UE to which implementations of the present disclosure is applied.

Referring to FIG. 5, a UE 100 may correspond to the first wireless device 100 of FIG. 2 and/or the first wireless device 100 of FIG. 4.

A UE 100 includes a processor 102, a memory 104, a transceiver 106, one or more antennas 108, a power management module 110, a battery 1112, a display 114, a keypad 116, a subscriber identification module (SIM) card 118, a speaker 120, and a microphone 122.

The processor 102 may be configured to implement the descriptions, functions, procedures, suggestions, methods and/or operational flowcharts disclosed in the present disclosure. The processor 102 may be configured to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of a digital signal processor (DSP), a central processing unit (CPU), a graphics processing unit (GPU), a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 110 manages power for the processor 102 and/or the transceiver 106. The battery 112 supplies power to the power management module 110.

The display 114 outputs results processed by the processor 102. The keypad 116 receives inputs to be used by the processor 102. The keypad 16 may be shown on the display 114.

The SIM card 118 is an integrated circuit that is intended to securely store the international mobile subscriber identity (IMSI) number and its related key, which are used to identify and authenticate subscribers on mobile telephony devices (such as mobile phones and computers). It is also possible to store contact information on many SIM cards.

The speaker 120 outputs sound-related results processed by the processor 102. The microphone 122 receives sound-related inputs to be used by the processor 102.

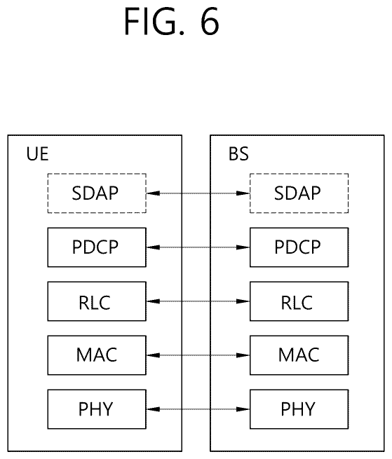

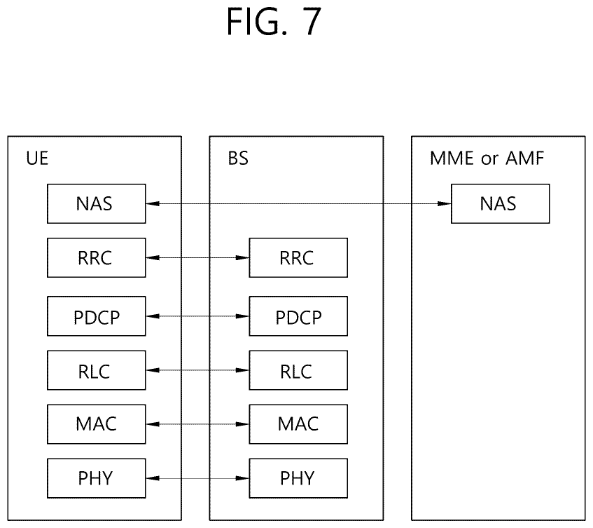

FIGS. 6 and 7 show an example of protocol stacks in a 3GPP based wireless communication system to which implementations of the present disclosure is applied.

In particular, FIG. 6 illustrates an example of a radio interface user plane protocol stack between a UE and a BS and FIG. 7 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 6, the user plane protocol stack may be divided into Layer 1 (i.e., a PHY layer) and Layer 2. Referring to FIG. 7, the control plane protocol stack may be divided into Layer 1 (i.e., a PHY layer), Layer 2. Layer 3 (e.g., an RRC layer), and a non-access stratum (NAS) layer. Layer 1, Layer 2 and Layer 3 are referred to as an access stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network quality of service (QOS) flows.

In the 3GPP NR system, the main services and functions of the MAC sublayer include: mapping between logical channels and transport channels: multiplexing/de-multiplexing of MAC SDUs belonging to one or different logical channels into/from transport blocks (TB) delivered to/from the physical layer on transport channels: scheduling information reporting: error correction through hybrid automatic repeat request (HARQ) (one HARQ entity per cell in case of carrier aggregation (CA)): priority handling between UEs by means of dynamic scheduling: priority handling between logical channels of one UE by means of logical channel prioritization: padding. A single MAC entity may support multiple numerologies, transmission timings and cells. Mapping restrictions in logical channel prioritization control which numerology(ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast control channel (BCCH) is a downlink logical channel for broadcasting system control information, paging control channel (PCCH) is a downlink logical channel that transfers paging information system information change notifications and indications of ongoing public warning service (PWS) broadcasts, common control channel (CCCH) is a logical channel for transmitting control information between UEs and network and used for UEs having no RRC connection with the network, and dedicated control channel (DCCH) is a point-to-point bi-directional logical channel that transmits dedicated control information between a UE and the network and used by UEs having an RRC connection. Dedicated traffic channel (DTCH) is a point-to-point logical channel, dedicated to one UE, for the transfer of user information. A DTCH can exist in both uplink and downlink. In downlink, the following connections between logical channels and transport channels exist: BCCH can be mapped to broadcast channel (BCH); BCCH can be mapped to downlink shared channel (DL-SCH); PCCH can be mapped to paging channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to uplink shared channel (UL-SCH); DCCH can be mapped to UL-SCH; and DTCH can be mapped to UL-SCH.

The RLC sublayer supports three transmission modes: transparent mode (TM), unacknowledged mode (UM), and acknowledged node (AM). The RLC configuration is per logical channel with no dependency on numerologies and/or transmission durations. In the 3GPP NR system, the main services and functions of the RLC sublayer depend on the transmission mode and include: transfer of upper layer PDUs: sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using robust header compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering: ciphering, deciphering and integrity protection: transfer of control plane data; reordering and duplicate detection: in-order delivery: duplication of PDCP PDUs and duplicate discard indication to lower layers.

In the 3GPP NR system, the main services and functions of SDAP include: mapping between a QoS flow and a data radio bearer: marking QoS flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5GC or NG-RAN; establishment, maintenance and release of an RRC connection between the UE and NG-RAN; security functions including key management; establishment, configuration, maintenance and release of signaling radio bearers (SRBs) and data radio bearers (DRBs); mobility functions (including: handover and context transfer. UE cell selection and reselection and control of cell selection and reselection, inter-RAT mobility); QoS management functions; UE measurement reporting and control of the reporting; detection of and recovery from radio link failure; NAS message transfer to/from NAS from/to UE.

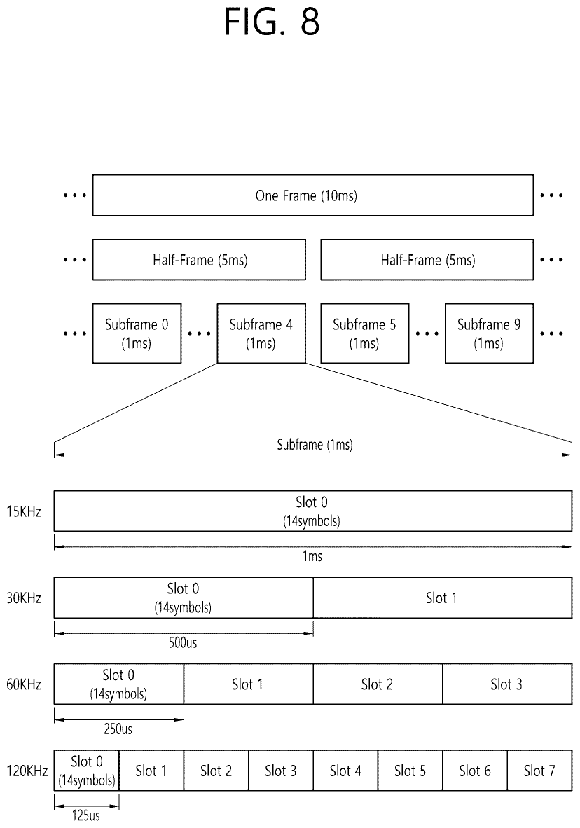

FIG. 8 shows a frame structure in a 3GPP based wireless communication system to which implementations of the present disclosure is applied.

The frame structure shown in FIG. 8 is purely exemplary and the number of subframes, the number of slots, and/or the number of symbols in a frame may be variously changed. In the 3GPP based wireless communication system, OFDM numerologies (e.g., subcarrier spacing (SCS), transmission time interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or CP-OFDM symbols), SC-FDMA symbols (or discrete Fourier transform-spread-OFDM (DFT-s-OFDM) symbols).

Referring to FIG. 8, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is 1 ms. Each subframe is divided into slots and the number of slots in a subframe depends on a subcarrier spacing. Each slot includes 14 or 12 OFDM symbols based on a cyclic prefix (CP). In a normal CP, each slot includes 14 OFDM symbols and, in an extended CP, each slot includes 12 OFDM symbols. The numerology is based on exponentially scalable subcarrier spacing Δf=2^{u}*15 KHz.

Table 1 shows the number of OFDM symbols per slot N^{slot}_{symb}, the number of slots per frame N^{frame,u}ₛₗₒₜ, and the number of slots per subframe N^{subframe,u}ₛₗₒₜ for the normal CP, according to the subcarrier spacing Δf=2^{u}*15 KHz.

TABLE 1

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 2 shows the number of OFDM symbols per slot N^{slot}_{symb}, the number of slots per frame N^{frame,u}ₛₗₒₜ, and the number of slots per subframe N^{subframe,u}ₛₗₒₜ for the extended CP, according to the subcarrier spacing Δf=2^{u}*15 KHz.

TABLE 2

| u | N^{slot}_{symb} | N^{frame, u}ₛₗₒₜ | N^{subframe, u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size,u}_{grid_x}*N^{RB}_{sc} subcarriers and N^{subframe,u}_{symb} OFDM symbols is defined, starting at common resource block (CRB) N^{start,u}_{grid} indicated by higher-layer signaling (e.g., RRC signaling), where N^{size,u}_{grid,x} is the number of resource blocks (RBs) in the resource grid and the subscript x is DL for downlink and UL for uplink. N^{RB}_{sc} is the number of subcarriers per RB. In the 3GPP based wireless communication system, N^{RB}_{sc} is 12 generally. There is one resource grid for a given antenna port p, subcarrier spacing configuration u, and transmission direction (DL or UL). The carrier bandwidth N^{size,u}_{grid} for subcarrier spacing configuration u is given by the higher-layer parameter (e.g., RRC parameter). Each element in the resource grid for the antenna port p and the subcarrier spacing configuration u is referred to as a resource element (RE) and one complex symbol may be mapped to each RE. Each RE in the resource grid is uniquely identified by an index k in the frequency domain and an index/representing a symbol location relative to a reference point in the time domain. In the 3GPP based wireless communication system, an RB is defined by 12 consecutive subcarriers in the frequency domain.

In the 3GPP NR system, RBs are classified into CRBs and physical resource blocks (PRBs). CRBs are numbered from 0 and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a bandwidth part (BWP) and numbered from 0) to N^{size}_{BWP,i}-1, where i is the number of the bandwidth part. The relation between the physical resource block n_{PRB} in the bandwidth part i and the common resource block n_{CRB} is as follows: n_{PRB}=N_{CRB}+N^{size}_{BWP,i}, Where N^{size}_{BWP,i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

The NR frequency band may be defined as two types of frequency range, i.e., FR1 and FR2. The numerical value of the frequency range may be changed. For example, the frequency ranges of the two types (FR1 and FR2) may be as shown in Table 3 below. For ease of explanation, in the frequency ranges used in the NR system, FR1 may mean “sub 6 GHz range”, FR2 may mean “above 6 GHz range,” and may be referred to as millimeter wave (mmW).

TABLE 3

| Frequency Range | Corresponding frequency | |
|---|---|---|
| designation | range | Subcarrier Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 4 below. That is, FR1 may include a frequency band of 6 GHz (or 5850, 5900, 5925 MHZ, etc.) or more. For example, a frequency band of 6 GHZ (or 5850, 5900, 5925 MHZ, etc.) or more included in FR1 may include an unlicensed band. Unlicensed bands may be used for a variety of purposes, for example for communication for vehicles (e.g., autonomous driving).

TABLE 4

| Frequency Range | Corresponding frequency | |
|---|---|---|
| designation | range | Subcarrier Spacing |
| FR1 | 410 MHz-7125 MHz | 15, 30, 60 kHz |
| FR2 | 24250 MHz-52600 MHz | 60, 120, 240 kHz |

In the present disclosure, the term “cell” may refer to a geographic area to which one or more nodes provide a communication system, or refer to radio resources. A “cell” as a geographic area may be understood as coverage within which a node can provide service using a carrier and a “cell” as radio resources (e.g., time-frequency resources) is associated with bandwidth which is a frequency range configured by the carrier. The “cell” associated with the radio resources is defined by a combination of downlink resources and uplink resources, for example, a combination of a DL component carrier (CC) and a UL CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times.

In CA, two or more CCs are aggregated. A UE may simultaneously receive or transmit on one or multiple CCs depending on its capabilities. CA is supported for both contiguous and non-contiguous CCs. When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the primary cell (PCell). The PCell is a cell, operating on the primary frequency, in which the UE either performs the initial connection establishment procedure or initiates the connection re-establishment procedure. Depending on UE capabilities, secondary cells (SCells) can be configured to form together with the PCell a set of serving cells. An SCell is a cell providing additional radio resources on top of special cell (SpCell). The configured set of serving cells for a UE therefore always consists of one PCell and one or more SCells. For dual connectivity (DC) operation, the term SpCell refers to the PCell of the master cell group (MCG) or the primary SCell (PSCell) of the secondary cell group (SCG). An SpCell supports PUCCH transmission and contention-based random access, and is always activated. The MCG is a group of serving cells associated with a master node, comprised of the SpCell (PCell) and optionally one or more SCells. The SCG is the subset of serving cells associated with a secondary node, comprised of the PSCell and zero or more SCells, for a UE configured with DC. For a UE in RRC_CONNECTED not configured with CA/DC, there is only one serving cell comprised of the PCell. For a UE in RRC_CONNECTED configured with CA/DC, the term “serving cells” is used to denote the set of cells comprised of the SpCell(s) and all SCells. In DC, two MAC entities are configured in a UE: one for the MCG and one for the SCG.

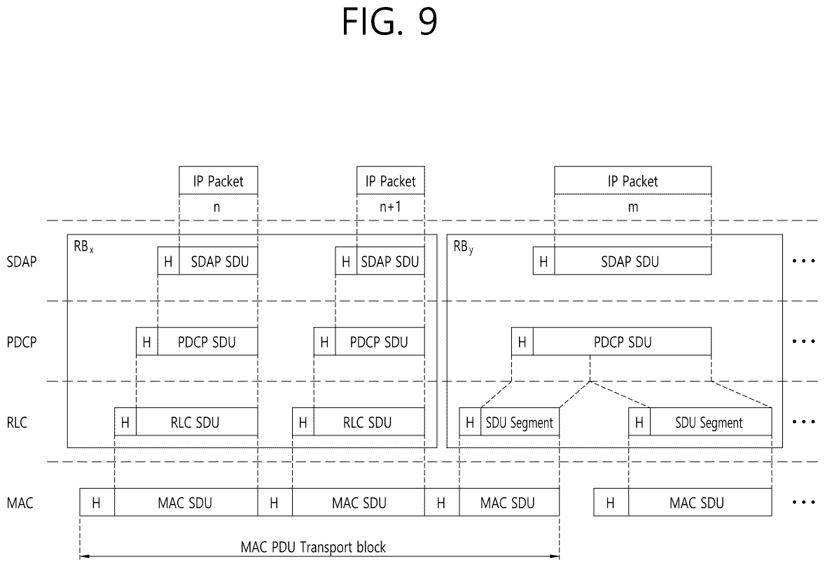

FIG. 9 shows a data flow example in the 3GPP NR system to which implementations of the present disclosure is applied.

Referring to FIG. 9. “RB” denotes a radio bearer, and “H” denotes a header. Radio bearers are categorized into two groups: DRBs for user plane data and SRBs for control plane data. The MAC PDU is transmitted/received using radio resources through the PHY layer to/from an external device. The MAC PDU arrives to the PHY layer in the form of a transport block.

In the PHY layer, the uplink transport channels UL-SCH and RACH are mapped to their physical channels PUSCH and PRACH, respectively, and the downlink transport channels DL-SCH, BCH and PCH are mapped to PDSCH, PBCH and PDSCH, respectively. In the PHY layer, uplink control information (UCI) is mapped to PUCCH, and downlink control information (DCI) is mapped to PDCCH. A MAC PDU related to UL-SCH is transmitted by a UE via a PUSCH based on an UL grant, and a MAC PDU related to DL-SCH is transmitted by a BS via a PDSCH based on a DL assignment.

Hereinafter, technical features related to the flight path are described. Parts of section 5.3.3.4, 5.5.4.16, 5.5.4.17, 5.6.5.3, and 6.2.2 of 3GPP TS 36.331 v16.6.0 may be referred.

Operations related to reception of the RRCConnectionSetup by the UE are described.

The UE shall:
1> set the content of RRCConnectionSetupComplete message as follows:
2> if the UE is connected to EPC:
3> except for NB-IoT:
4> include the mobilityState and set it to the mobility state of the UE just prior to entering RRC_CONNECTED state;
4> if the UE has flight path information available:
5> include flightPathInfoAvailable:

Operations related to reception of the UEInformationRequest message are described.
1> except for NB-IoT, if flightPathInfoReq field is present and the UE has flight path information available:
2> include the flightPathInfoReport and set it to include the list of waypoints along the flight path;
2> if the include TimeStamp is set to TRUE:
3> set the field timeStamp to the time when UE intends to arrive to each waypoint if this information is available at the UE:

Technical features related to a UEInformationRequest message are described. The UEInformationRequest is the command used by E-UTRAN to retrieve information from the UE.

For example, signalling radio bearer for the UEInformationRequest may include SRB1. RLC-Service Access Point (SAP) for the UEInformationRequest may include AM. Logical channel for the UEInformationRequest may include DCCH. Direction for the UEInformationRequest may be E-UTRAN to UE.

The UEInformationRequest may include information on a flightPathInfoReq (for example, FlightPathInfoReportConfig) and/or information on nonCriticalExtension.

Technical features related to a UEInformationResponse message are described. For example, the UEInformationResponse message is used by the UE to transfer the information requested by the E-UTRAN.

For example, signalling radio bearer for the UEInformationResponse may include SRB1 or SRB2 (when logged measurement information is included). RLC-SAP for the UEInformationResponse may include an AM. Logical channel for the UEInformationResponse may include a DCCH. Direction for the UEInformationResponse may be UE to E-UTRAN.

For example, UEInformationResponse message may include a flightPathInfoReport. For example, the flightPathInfoReport may include information on one or more flightPaths and/or one or more way PointLocations.

Technical features related to LocationInfo are described. For example, the IE LocationInfo is used to transfer detailed location information available at the UE to correlate measurements and UE position information.

For example, LocationInfo information element may include verticalVelocity Info including information on a verticalVelocity and a verticalVelocity AndUncertainty.

For example, a verticalVelocity AndUncertainty may include information on a parameter verticalVelocity AndUncertainty corresponds to horizontal With VerticalVelocity AndUncertainty. The first/leftmost bit of the first octet contains the most significant bit.

For example, a verticalVelocity may include information on a parameter verticalVelocity corresponds to horizontalWithVerticalVelocity. The first/leftmost bit of the first octet contains the most significant bit.

UE operations related to Event H1 (The Aerial UE height is above a threshold) are described.

The UE shall:
1> consider the entering condition for this event to be satisfied when condition H1-1, as specified below, is fulfilled;
1> consider the leaving condition for this event to be satisfied when condition H1-2, as specified below, is fulfilled;

### Inequality H1-1 (Entering Condition)

$$Ms - Hys > Thresh + Offset$$

### Inequality H1-2 (Leaving Condition)

$$Ms + Hys < Thresh + Offset$$

The variables in the formula are defined as follows:

Ms is the Aerial UE height, not taking into account any offsets.

Hys is the hysteresis parameter (i.e. h1-Hysteresis as defined within ReportConfigEUTRA) for this event.

Thresh is the reference threshold parameter for this event given in MeasConfig (i.e. heightThreshRef as defined within MeasConfig).

Offset is the offset value to heightThreshRef to obtain the absolute threshold for this event. (i.e. h1-ThresholdOffset as defined within ReportConfigEUTRA)

Ms is expressed in meters.

Thresh is expressed in the same unit as Ms.

UE operations related to Event H2 (The Aerial UE height is below a threshold) are described.

The UE shall:
1> consider the entering condition for this event to be satisfied when condition H2-1, as specified below, is fulfilled;
1> consider the leaving condition for this event to be satisfied when condition H2-2, as specified below, is fulfilled;

### Inequality H2-1 (Entering Condition)

$$Ms + Hys < Thresh + Offset$$

### Inequality H2-2 (Leaving Condition)

$$Ms - Hys > Thresh + Offset$$

The variables in the formula are defined as follows:

Ms is the Aerial UE height, not taking into account any offsets.

Hys is the hysteresis parameter (i.e. h2-Hysteresis as defined within ReportConfigEUTRA) for this event.

Thresh is the reference threshold parameter for this event given in MeasConfig (i.e. heightThreshRef as defined within MeasConfig).

Offset is the offset value to heightThreshRef to obtain the absolute threshold for this event. (i.e. h2-ThresholdOffset as defined within ReportConfigEUTRA)

Ms is expressed in meters.

Thresh is expressed in the same unit as Ms.

Hereinafter, technical features related to Aerial UE communication are described. Parts of section 23.17 of 3GPP TS 36.300 v16.5.0 may be referred.

E-UTRAN based mechanisms providing LTE connection to UEs capable of Aerial communication are supported via the following functionalities:
subscription-based Aerial UE identification and authorization.
height reporting based on the event that the UE's altitude has crossed a network-configured reference altitude threshold.
interference detection based on a measurement reporting that is triggered when a configured number of cells (i.e. larger than one) fulfills the triggering criteria simultaneously.
signalling of flight path information from UE to E-UTRAN.
Location information reporting, including UE's horizontal and vertical velocity.

### [Subscription Based Identification of Aerial UE Function]

Support of Aerial UE function is stored in the user's subscription information in HSS. HSS transfers this information to the MME during Attach, Service Request and Tracking Area Update procedures.

The subscription information can be provided from the MME to the eNB via the S1 AP Initial Context Setup Request during Attach, Tracking Area Update and Service Request procedures. In addition, for X2-based handover, the source eNodeB can include the subscription information in the X2-AP Handover Request message to the target eNodeB.

For the intra and inter MME S1 based handover, the MME provides the subscription information to the target eNB after the handover procedure.

### [Height Based Reporting for Aerial UE Communication]

An aerial UE can be configured with event based height reporting. UE sends height report when the altitude of the aerial UE is above or below a configured threshold. The report contains height and location if configured.

### [Interference Detection and Mitigation for Aerial UE Communication]

For interference detection, an aerial UE can be configured with RRM event A3, A4 or A5 that triggers measurement report when individual (per cell) RSRP values for a configured number of cells fulfil the configured event. The report contains RRM results and location if configured.

For interference mitigation an aerial UE can be configured with a dedicated UE-specific alpha parameter for PUSCH power control.

### [Flight Path Information Reporting]

E-UTRAN can request a UE to report flight path information consisting of a number of waypoints defined as 3D locations. A UE reports up to configured number of waypoints if flight path information is available at the UE. The report can consist also time stamps per waypoint if configured in the request and if available at the UE.

### [Location Reporting for Aerial UE Communication]

Location information for Aerial UE communication can include horizontal and vertical speed if configured. Location information can be included in RRM report and in height report.

Hereinafter, technical features related to Conditional mobility are described. Parts of section 5.3.5.13 of 3GPP TS 38.331 v17.0.0 may be referred.

The network configures the UE with one or more candidate target SpCells in the conditional reconfiguration. The UE evaluates the condition of each configured candidate target SpCell. The UE applies the conditional reconfiguration associated with one of the target SpCells which fulfils associated execution condition. The network provides the configuration parameters for the target SpCell in the ConditionalReconfiguration IE.

The UE performs the following actions based on a received

### ConditionalReconfiguration IE:

1> if the ConditionalReconfiguration contains the condReconfigToRemoveList:
2> perform conditional reconfiguration removal procedure;
1> if the ConditionalReconfiguration contains the condReconfigToAddModList:
2> perform conditional reconfiguration addition/modification;

### [Conditional Reconfiguration Removal]

The UE shall:
1> for each condReconfigId value included in the condReconfigToRemoveList that is part of the current UE conditional reconfiguration in VarConditionalReconfig:
2> remove the entry with the matching condReconfigId from the VarConditionalReconfig:

NOTE: The UE does not consider the message as erroneous if the condReconfigToRemoveList includes any condReconfigId value that is not part of the current UE configuration.

### [Conditional Reconfiguration Addition/Modification]

For each condReconfigId received in the condReconfigToAddModList IE the UE shall:
1> if an entry with the matching condReconfigId exists in the condReconfigToAddModList within the VarConditionalReconfig:
2> if the entry in condReconfigToAddModList includes an condExecutionCond or condExecutionCondSCG;
3> replace condExecutionCond or condExecutionCondSCG within the VarConditionalReconfig with the value received for this condReconfigId;
2> if the entry in condReconfigToAddModList includes an condRRCReconfig;
3> replace condRRCReconfig within the VarConditionalReconfig with the value received for this condReconfigId;
1> else:
2> add a new entry for this condReconfigId within the VarConditionalReconfig;
1> perform conditional reconfiguration evaluation:

### [Conditional Reconfiguration Evaluation]

The UE shall:
1> for each condReconfigId within the VarConditionalReconfig:
2> if the RRCReconfiguration within condRRCReconfig includes the masterCellGroup including the reconfigurationWithSync, consider the cell which has a physical cell identity matching the value indicated in the ServingCellConfigCommon included in the reconfigurationWithSync within the masterCellGroup in the received condRRCReconfig to be applicable cell;
2> if the RRCReconfiguration within condRRCReconfig includes the secondaryCellGroup including the reconfigurationWithSync, consider the cell which has a physical cell identity matching the value indicated in the ServingCellConfigCommon included in the reconfigurationWithSync within the secondaryCellGroup within the received condRRCReconfig to be applicable cell;
2> if condExecutionCondSCG is configured:
3> in the remainder of the procedures, consider each measId indicated in the condExecutionCondSCG as a measId in the VarMeasConfig associated with the SCG measConfig;
2> if condExecutionCond is configured:
3> if it is configured via SRB3 or configured within nr-SCG or within nr-SecondaryCellGroupConfig via SRB1:
4> in the remainder of the procedures, consider each measId indicated in the condExecutionCond as a measId in the VarMeasConfig associated with the SCG measConfig;
3> otherwise:
4> in the remainder of the procedures, consider each measId indicated in the condExecutionCond as a measId in the VarMeasConfig associated with the MCG measConfig;
2> for each measId included in the measIdList within VarMeasConfig indicated in the condExecutionCond or condExecutionCondSCG associated to condReconfigId:
3> if the condEventId is associated with condEventT1, and if the entry condition(s) applicable for this event associated with the condReconfigId, i.e. the event corresponding with the condEventId(s) of the corresponding condTriggerConfig within VarConditionalReconfig, is fulfilled for the applicable cells: or
3> if the condEventId is associated with condEventDI, and if the entry condition(s) applicable for this event associated with the condReconfigId, i.e. the event corresponding with the condEventId(s) of the corresponding condTriggerConfig within VarConditionalReconfig, is fulfilled for the applicable cells during the corresponding timeToTrigger defined for this event within the VarConditionalReconfig: or
3> if the condEventId is associated with condEventA3, condEventA4 or condEventA5, and if the entry condition(s) applicable for this event associated with the condReconfigId, i.e. the event corresponding with the condEventId(s) of the corresponding condTriggerConfig within VarConditionalReconfig, is fulfilled for the applicable cells for all measurements after layer 3 filtering taken during the corresponding timeToTrigger defined for this event within the VarConditionalReconfig:
4> consider the event associated to that measId to be fulfilled;
3> if the measId for this event associated with the condReconfigId has been modified: or
3> if the condEventId is associated with condEventT1, and if the leaving condition(s) applicable for this event associated with the condReconfigId, i.e. the event corresponding with the condEventId(s) of the corresponding condTriggerConfig within VarConditionalReconfig, is fulfilled for the applicable cells: or
3> if the condEventId is associated with condEventDI, and if the leaving condition(s) applicable for this event associated with the condReconfigId, i.e. the event corresponding with the condEventId(s) of the corresponding condTriggerConfig within VarConditionalReconfig, is fulfilled for the applicable cells during the corresponding timeToTrigger defined for this event within the VarConditionalReconfig: or
3> if the condEventId is associated with condEventA3, condEventA4 or condEventA5, and if the leaving condition(s) applicable for this event associated with the condReconfigId, i.e. the event corresponding with the condEventId(s) of the corresponding condTriggerConfig within VarConditionalReconfig, is fulfilled for the applicable cells for all measurements after layer 3 filtering taken during the corresponding timeToTrigger defined for this event within the VarConditionalReconfig:
4> consider the event associated to that measId to be not fulfilled;
2> if event(s) associated to all measId(s) within condTriggerConfig for a target candidate cell within the stored condRRCReconfig are fulfilled:
3> consider the target candidate cell within the stored condRRCReconfig, associated to that condReconfigId, as a triggered cell;
3> initiate the conditional reconfiguration execution:

Up to 2 MeasId can be configured for each condReconfigId. The conditional reconfiguration event of the 2 MeasId may have the same or different event conditions, triggering quantity, time to trigger, and triggering threshold.

### [Conditional Reconfiguration Evaluation of SN Initiated Inter-SN CPC for EN-DC]

The UE shall:
1> for each condReconfigId within the VarConditionalReconfig:
1> in the remainder of the procedures, consider each measId indicated in the IE of CondReconfigExecCondSN contained in the triggerConditionSN, as a measId in the VarMeasConfig associated with the SCG measConfig;
1> for each measId included in the measIdList within VarMeasConfig indicated in the CondReconfigExecCondSN contained in the triggerConditionSN associated to the condReconfigurationId:
2> if the entry condition(s) applicable for the event associated with that measId, is fulfilled for the applicable cells for all measurements after layer 3 filtering taken during the corresponding timeToTrigger defined for this event associated with that measId:
3> consider this event to be fulfilled;
2> if the measId for this event has been modified; or
2> if the leaving condition(s) applicable for this event associated with that measId, is fulfilled for the applicable cells for all measurements after layer 3 filtering taken during the corresponding timeToTrigger defined for this event associated with that measId:
3> consider this event associated to that measId to be not fulfilled;
1> if trigger conditions for all events associated with the measId(s) indicated in the IE of CondReconfigExecCondSN contained in the triggerConditionSN, are fulfilled:
2> consider the target cell candidate within the RRCReconfiguration message contained in nr-SecondaryCellGroupConfig in the RRCConnectionReconfiguration message contained in the stored condReconfigurationToApply, associated to that condReconfigurationId as a triggered cell:

2> initiate the conditional reconfiguration execution:

If multiple NR cells are triggered in conditional reconfiguration execution, it is up to UE implementation which one to select, e.g. the UE considers beams and beam quality to select one of the triggered cells for execution.

### [Conditional Reconfiguration Execution]

The UE shall:
1> if more than one triggered cell exists:
2> select one of the triggered cells as the selected cell for conditional reconfiguration execution;
1> else;
2> consider the triggered cell as the selected cell for conditional reconfiguration execution;
1> for the selected cell of conditional reconfiguration execution:
2> apply the stored condRRCReconfig of the selected cell and perform the actions:

If multiple NR cells are triggered in conditional reconfiguration execution, it is up to UE implementation which one to select, e.g. the UE considers beams and beam quality to select one of the triggered cells for execution.

Hereinafter, technical features related to Cell Reselection evaluation process are described. Parts of section 5.2.4 of 3GPP TS 38.331 v17.0.0 may be referred.

Cell Reselection evaluation process

### [Reselection Priorities Handling]

Absolute priorities of different NR frequencies or inter-RAT frequencies may be provided to the UE in the system information, in the RRCRelease message, or by inheriting from another RAT at inter-RAT cell (re) selection. In the case of system information, an NR frequency or inter-RAT frequency may be listed without providing a priority (i.e. the field cellReselectionPriority is absent for that frequency). If any fields with cellReselectionPriority are provided in dedicated signalling, the UE shall ignore any fields with cellReselectionPriority and any slice reselection information provided in system information. If slice reselection information is provided in dedicated signaling, the UE shall ignore slice reselection information provided in system information.

If UE is in camped normally state and UE supports slice-based cell reselection, UE shall derive re-selection priorities.

If UE is in camped on any cell state. UE shall only apply the priorities provided by system information from current cell, and the UE preserves priorities provided by dedicated signalling and deprioritisationReq received in RRCRelease unless specified otherwise. When the UE in camped normally state, has only dedicated priorities other than for the current frequency, the UE shall consider the current frequency to be the lowest priority frequency (i.e. lower than any of the network configured values). When the HSDN capable UE is in High-mobility state, the UE shall always consider the HSDN cells to be the highest priority (i.e., higher than any other network configured priorities). When the HSDN capable UE is not in High-mobility state, the UE shall always consider HSDN cells to be the lowest priority (i.e., lower than any other network configured priorities). If the UE is configured to perform both NR sidelink communication and V2X sidelink communication, the UE may consider the frequency providing both NR sidelink communication configuration and V2X sidelink communication configuration to be the highest priority. If the UE is configured to perform NR sidelink communication and not perform V2X communication, the UE may consider the frequency providing NR sidelink communication configuration to be the highest priority. If the UE is configured to perform V2X sidelink communication and not perform NR sidelink communication, the UE may consider the frequency providing V2X sidelink communication configuration to be the highest priority.

The frequency only providing the anchor frequency configuration should not be prioritized for V2X service during cell reselection.

When UE is configured to perform NR sidelink communication or V2X sidelink communication performs cell reselection, it may consider the frequencies providing the intra-carrier and inter-carrier configuration have equal priority in cell reselection.

The prioritization among the frequencies which UE considers to be the highest priority frequency is left to UE implementation.

The UE is configured to perform V2X sidelink communication or NR sidelink communication, if it has the capability and is authorized for the corresponding sidelink operation.

When UE is configured to perform both NR sidelink communication and V2X sidelink communication, but cannot find a frequency which can provide both NR sidelink communication configuration and V2X sidelink communication configuration, UE may consider the frequency providing either NR sidelink communication configuration or V2X sidelink communication configuration to be the highest priority.

The UE is configured with either dedicated cell reselection priorities or slice or slice group specific frequency priorities in the RRCRelease message.

The UE shall only perform cell reselection evaluation for NR frequencies and inter-RAT frequencies that are given in system information and for which the UE has a priority provided.

If the MBS broadcast capable UE is receiving or interested to receive an MBS broadcast service(s) and can only receive this MBS broadcast service(s) by camping on a frequency on which it is provided, the UE may consider that frequency to be the highest priority during the MBS broadcast session as long as the two following conditions are fulfilled:
1) The cell reselected by the UE due to frequency prioritization for MBS is providing SIB20;
2) Either:
   One or more MBS FSAI(s) of that frequency is indicated in SIB21 of the serving cell and the same MBS FSAI(s) is also indicated for this MBS broadcast service in MBS User Service Description (USD), or
   SIB21 is not provided in the serving cell and that frequency is included in the USD of this service, or
   SIB21 is provided in the serving cell but does not provide the frequency mapping for the concerned service, and that frequency is included in the USD of this service.

It is up to UE implementation how to use information in USD to determine whether/how to do the frequency prioritization for specific frequency/frequencies included in USD.

If the MBS broadcast capable UE is receiving or interested to receive an MBS broadcast service(s), the UE may consider cell reselection candidate frequencies at which it cannot receive the MBS broadcast service to be of the lowest priority during the MBS broadcast session, as long as the SIB20 is provided by the cell on the MBS frequency which the UE monitors and as long as the condition 2) above is fulfilled for the serving cell.

In case UE receives RRCRelease with deprioritisationReq, UE shall consider current frequency and stored frequencies due to the previously received RRCRelease with deprioritisationReq or all the frequencies of NR to be the lowest priority frequency (i.e. lower than any of the network configured values) while T325 is running irrespective of camped RAT. The UE shall delete the stored deprioritisation request(s) when a PLMN selection or SNPN selection is performed on request by NAS.

UE should search for a higher priority layer for cell reselection as soon as possible after the change of priority. The minimum related performance requirements are still applicable.

The UE shall delete priorities provided by dedicated signalling when:
the UE enters a different RRC state: or
the optional validity time of dedicated priorities (T320) expires: or
the UE receives an RRCRelease message with the field cellReselectionPriorities absent: or
a PLMN selection or SNPN selection is performed on request by NAS.

Equal priorities between RATs are not supported.

The UE shall not consider any exclude-listed cells as candidate for cell reselection.

The UE shall consider only the allow-listed cells, if configured, as candidates for cell reselection.

The UE in RRC_IDLE state shall inherit the priorities provided by dedicated signalling and the remaining validity time (i.e. T320 in NR and E-UTRA), if configured, at inter-RAT cell (re) selection.

The network may assign dedicated cell reselection priorities for frequencies not configured by system information.

### [Measurement Rules for Cell Re-Selection]

Following rules are used by the UE to limit needed measurements:
If the serving cell fulfils Srxlev>S_{IntraSearchP} and Squal>S_{IntraSearchQ}:
If distanceThresh is broadcasted in SIBxx, and if UE supports location-based measurement initiation and has valid UE location information:
If the distance between UE and the serving cell reference location is shorter than distanceThresh, the UE may choose not to perform intra-frequency measurements;
Otherwise, the UE shall perform intra-frequency measurements;
Otherwise, the UE may choose not to perform intra-frequency measurements;
Otherwise, the UE shall perform intra-frequency measurements.
The UE shall apply the following rules for NR inter-frequencies and inter-RAT frequencies which are indicated in system information and for which the UE has priority:
For a NR inter-frequency or inter-RAT frequency with a reselection priority higher than the reselection priority of the current NR frequency, the UE shall perform measurements of higher priority NR inter-frequency or inter-RAT frequencies.
For a NR inter-frequency with an equal or lower reselection priority than the reselection priority of the current NR frequency and for inter-RAT frequency with lower reselection priority than the reselection priority of the current NR frequency:
If the serving cell fulfils Srxlev>S_{nonIntraSearchP} and Squal>S_{nonIntraSearchQ}:
If distanceThresh is broadcasted in SIBxx, and if UE supports location-based measurement initiation and has valid UE location information:
If the distance between UE and the serving cell reference location is shorter than distanceThresh, the UE may choose not to perform measurements of NR inter-frequency cells of equal or lower priority, or inter-RAT frequency cells of lower priority;
Otherwise, the UE shall perform measurements of NR inter-frequency cells of equal or lower priority, or inter-RAT frequency cells of lower priority;
Otherwise, the UE may choose not to perform measurements of NR inter-frequency cells of equal or lower priority, or inter-RAT frequency cells of lower priority;
Otherwise, the UE shall perform measurements of NR inter-frequency cells of equal or lower priority, or inter-RAT frequency cells of lower priority.
If the UE supports relaxed measurement and relaxedMeasurement is present in SIB2, the UE may further relax the needed measurements.

If the t-Service of the serving cell is present in SIB19, UE should start to perform intra-frequency, inter-frequency or inter-RAT measurements before the t-Service, regardless of the distance between UE and the serving cell reference location or whether the serving cell fulfils Srxlev>SIntraSearchP and Squal>SIntraSearchQ, or Srxlev>SnonIntraSearchP and Squal>SnonIntraSearchQ and the exact time to start measurement before t-Service is up to UE implementation. UE shall perform measurements of higher priority NR inter-frequency or inter-RAT frequencies regardless of the remaining service time of the serving cell.

When evaluating the distance between UE and the serving cell reference location, it's up to UE implementation to have available UE location information.

### [Mobility States of a UE]

The UE mobility state is determined if the parameters (T_{CRmax}, N_{CR_H}, N_{CR_M}, T_{CRmaxHyst} and cellEquivalentSize) are broadcasted in system information for the serving cell.

### State Detection Criteria:

Normal-mobility state criteria:
If number of cell reselections during time period T_{CRmax} is less than N_{CR_M}.

Medium-mobility state criteria:
If number of cell reselections during time period T_{CRmax} is greater than or equal to N_{CR_M} but less than or equal to N_{CR_H}.

High-mobility state criteria:
If number of cell reselections during time period T_{CRmax} is greater than N_{CR_H}.

The UE shall not consider consecutive reselections where a cell is reselected again right after one reselection for mobility state detection criteria. If the UE is capable of HSDN and the cellEquivalentSize is configured, the UE counts the number of cell reselections for this cell as cellEquivalentSize configured for this cell.

### State Transitions:

The UE shall:
if the criteria for High-mobility state is detected:
enter High-mobility state.
else if the criteria for Medium-mobility state is detected:
enter Medium-mobility state.
else if criteria for either Medium- or High-mobility state is not detected during time period T_{CRmaxHyst}:
enter Normal-mobility state.

If the UE is in High- or Medium-mobility state, the UE shall apply the speed dependent scaling rules.

### [Scaling Rules]

UE shall apply the following scaling rules:
If neither Medium-nor High-mobility state is detected:
no scaling is applied.
If High-mobility state is detected:
Add the sf-High of “Speed dependent ScalingFactor for Q_{hyst}” to Q_{hyst} if broadcasted in system information;
For NR cells, multiply Treselection_{NR} by the sf-High of “Speed dependent ScalingFactor for Treselection_{NR}” if broadcasted in system information;
For EUTRA cells, multiply Treselection_{EUTRA} by the sf-High of “Speed dependent ScalingFactor for Treselection_{EUTRA}” if broadcasted in system information.
If Medium-mobility state is detected:
Add the sf-Medium of “Speed dependent ScalingFactor for Q_{hyst}” to Q_{hyst} if broadcasted in system information;
For NR cells, multiply Treselection_{NR} by the sf-Medium of “Speed dependent ScalingFactor for Treselection_{NR}” if broadcasted in system information;
For EUTRA cells, multiply Treselection_{EUTRA} by the sf-Medium of “Speed dependent ScalingFactor for Treselection_{EUTRA}” if broadcasted in system information.

In case scaling is applied to any Treselection_{RAT} parameter, the UE shall round up the result after all scalings to the nearest second.

[Cells with Cell Reservations, Access Restrictions or Unsuitable for Normal Camping]

For the highest ranked cell (including serving cell) according to cell reselection criteria, for the best cell according to absolute priority reselection criteria, the UE shall check if the access is restricted.

If that cell and other cells have to be excluded from the candidate list, the UE shall not consider these as candidates for cell reselection. This limitation shall be removed when the highest ranked cell changes.

If the highest ranked cell or best cell according to absolute priority reselection rules is an intra-frequency or inter-frequency cell which is not suitable due to one or more of the following reasons:
this cell belongs to a PLMN which is not indicated as being equivalent to the registered PLMN, or
this cell is a CAG cell that belongs to a PLMN which is equivalent to the registered PLMN but with no CAG-ID that is present in the UE's allowed CAG list being broadcasted, or
this cell is not a CAG cell and the CAG-only indication in the UE is set, or
this cell does not belong to a SNPN that is equal to the registered or selected SNPN of the UE in SNPN access mode,
the UE shall not consider this cell and, for operation in licensed spectrum, other cells on the same frequency as candidates for reselection for a maximum of 300 seconds.

For operation with shared spectrum channel access, when the highest ranked cell or best cell is not a candidate for reselection per the previous paragraph, the UE should continue to consider other cells on the same frequency for cell reselection, however if the second highest ranked cell on this frequency is also not suitable due to one or more of the above reasons, the UE may consider this frequency to be the lowest priority for a maximum of 300 seconds.

If the highest ranked cell or best cell according to absolute priority reselection rules is an intra-frequency or inter-frequency cell which is not suitable due to being part of the “list of 5GS forbidden TAs for roaming”, the UE shall not consider this cell and other cells on the same frequency as candidates for reselection for a maximum of 300 seconds.

If the highest ranked cell or best cell according to absolute priority reselection rules is an inter-RAT cell which is not suitable due to being part of the “list of forbidden TAs for roaming” or belonging to a PLMN which is not indicated as being equivalent to the registered PLMN, the UE shall not consider this cell and other cells on the same frequency, as candidates for reselection for a maximum of 300 seconds.

If the UE enters into state any cell selection, any limitation shall be removed. If the UE is redirected under NR control to a frequency for which the timer is running, the limitation(s) on that frequency shall be removed.

### [NR Inter-Frequency and Inter-RAT Cell Reselection Criteria]

If threshServingLowQ is broadcast in system information and more than 1 second has elapsed since the UE camped on the current serving cell, cell reselection to a cell on a higher priority NR frequency or inter-RAT frequency than the serving frequency shall be performed if:
A cell of a higher priority NR or EUTRAN RAT/frequency fulfils Squal>Thresh_{X, HighQ} during a time interval Treselection_{RAT}

Otherwise, cell reselection to a cell on a higher priority NR frequency or inter-RAT frequency than the serving frequency shall be performed if:
A cell of a higher priority RAT/frequency fulfils Srxlev>Thresh_{X, HighP} during a time interval Treselection_{RAT}; and
More than 1 second has elapsed since the UE camped on the current serving cell.

Cell reselection to a cell on an equal priority NR frequency shall be based on ranking for intra-frequency cell reselection.

If threshServingLowQ is broadcast in system information and more than 1 second has elapsed since the UE camped on the current serving cell, cell reselection to a cell on a lower priority NR frequency or inter-RAT frequency than the serving frequency shall be performed if:
The serving cell fulfils Squal<Thresh_{Serving, LowQ} and a cell of a lower priority NR or E-UTRAN RAT/frequency fulfils Squal>Thresh_{X, LowQ} during a time interval Treselection_{RAT}.

Otherwise, cell reselection to a cell on a lower priority NR frequency or inter-RAT frequency than the serving frequency shall be performed if:
The serving cell fulfils Srxlev<Thresh_{Serving, LowP} and a cell of a lower priority RAT/frequency fulfils Srxlev>Thresh_{X, LowP} during a time interval Treselection_{RAT}; and
More than 1 second has elapsed since the UE camped on the current serving cell

For a UE performing slice-based cell reselection if a cell fulfils the above criteria for cell reselection based on re-selection priority for the frequency and slice group, but this cell does not support the slice group, the UE shall re-derive a re-selection priority for the frequency by considering the slice group(s) supported by this cell (rather than those of the corresponding NR frequency). This reselection priority shall be used until the highest ranked cell changes on the frequency, or new slice or slice group priorities are received from NAS. UE shall ensure the cell reselection criteria above are fulfilled based on the newly derived priorities.

Cell reselection to a higher priority RAT/frequency shall take precedence over a lower priority RAT/frequency if multiple cells of different priorities fulfil the cell reselection criteria.

If more than one cell meets the above criteria, the UE shall reselect a cell as follows:
If the highest-priority frequency is an NR frequency, the highest ranked cell among the cells on the highest priority frequency (ies) meeting the criteria;
If the highest-priority frequency is from another RAT, the strongest cell among the cells on the highest priority frequency (ies) meeting the criteria of that RAT.

### [Intra-Frequency and Equal Priority Inter-Frequency Cell Reselection Criteria]

The cell-ranking criterion Rₛ for serving cell and Rn for neighbouring cells is defined by:

$${R}_{s} = {Q}_{meas , s} + {Q}_{hyst} - {Qoffset}_{temp}$$

$${R}_{n} = {Q}_{meas , n} - Qoffset - {Qoffset}_{temp}$$

TABLE 5

| | |
|---|---|
| Qₘₑₐₛ | RSRP measurement quantity used in cell reselections. |
| Qoffset | For intra-frequency: Equals to Qoffset_{s, n}, if Qoffset_{s, n} |
| | is valid, otherwise this equals to zero. |
| | For inter-frequency: Equals to Qoffset_{s, n} plus |
| | Qoffset_{frequency}, if Qoffset_{s, n} is valid, otherwise this |
| | equals to Qoffset_{frequency}. |
| Qoffsetₜₑₘₚ | Offset temporarily applied to a cell. |

The UE shall perform ranking of all cells that fulfil the cell selection criterion S. The cells shall be ranked according to the R criteria specified above by deriving Q_{meas,n} and Q_{meas,s} and calculating the R values using averaged RSRP results.

If rangeToBestCell is not configured, the UE shall perform cell reselection to the highest ranked cell. If this cell is found to be not-suitable.

If rangeToBestCell is configured, then the UE shall perform cell reselection to the cell with the highest number of beams above the threshold (i.e. absThreshSS-BlocksConsolidation) among the cells whose R value is within rangeToBestCell of the R value of the highest ranked cell. If there are multiple such cells, the UE shall perform cell reselection to the highest ranked cell among them. If this cell is found to be not-suitable.

In all cases, the UE shall reselect the new cell, only if the following conditions are met:
the new cell is better than the serving cell according to the cell reselection criteria specified above during a time interval Treselection_{RAT};
more than 1 second has elapsed since the UE camped on the current serving cell.

If rangeToBestCell is configured but absThreshSS-BlocksConsolidation is not configured on an NR frequency, the UE considers that there is one beam above the threshold for each cell on that frequency.

### [Inter-RAT Cell Reselection in RRC_INACTIVE State]

For UE in the RRC_INACTIVE state, upon cell reselection to another RAT, UE transitions from RRC_INACTIVE to RRC_IDLE and performs actions.

### [Re-Selection Priorities for Slice-Based Cell Reselection]

The UE derives re-selection priorities for slice-based cell re-selection by using:
a list of prioritized slice groups provided by NAS in priority order,
sliceInformation per frequency with sliceSpecificCellReselectionPriority per slice group, if provided system information and/or dedicated signalling,
cellReselectionPriority per frequency provided in system information and/or dedicated signalling.

The UE considers an NR frequency to support a slice group if
the NR frequency is included in sliceInformation and indicates support for the slice group.

The UE considers a cell on an NR frequency to support a slice group if
the NR frequency is included in sliceInformation and supports the said slice group; and
the cell is either listed in the sliceAllowCellListNR (if provided in system information of the serving cell and/or dedicated signalling): or
the cell is not listed in the sliceExcludeCellListNR (if provided in system information of the serving cell and/or dedicated signalling).

The UE shall derive re-selection priorities for slice-based cell re-selection according to the following rules:
Frequencies that support at least one prioritized slice group received from NAS have higher re-selection priority than frequencies that support no prioritized slice groups.
Frequencies that support at least one slice group are prioritised in the order of the NAS-provided priority for the highest prioritised slice group of the frequency.
Among the frequencies that support the same highest prioritised slice group, the frequencies are prioritized in the order of their per slice group sliceSpecificCellReselectionPriority.
Frequencies that support a prioritized slice group and that indicate per slice group sliceSpecificCellReselectionPriority have higher re-selection priority than frequencies that support this prioritized slice group without indicating per slice group sliceSpecificCellReselectionPriority.
Frequencies that support no prioritized slice group are prioritized in the order of their cellReselectionPriority;

Meanwhile, as the altitude of aerial UEs increases, they experience a line-of-sight propagation condition to more cells, resulting in faraway cells becoming more visible to them. Consequently, aerial UEs will receive interference from more cells in the downlink and cause interference to more cells in the uplink. Additionally, the aerial coverage becomes fragmented at higher altitudes. Typically, terrestrial UEs are served by the closest network as the main lobe points towards the ground. In contrast, aerial UEs are served by a side lobe of a neighbor network located far from the aerial UE. Therefore, the faraway network can become the serving network, and the cell coverage may not be continuous.

As aerial UEs fly across multiple cells at a particular height and direction, the quality of their serving cell fluctuates with a certain frequency based on network evaluation. Aerial UEs can see multiple cells with similar signal strength, making it difficult to select a suitable cell based on cell quality alone, such as RSRP and RSRQ. Especially in the case of conditional mobility, such as a conditional handover (CHO) and a Conditional PSCell Addition/Change (CPAC), if the aerial UE detects more neighbor cells, the UE may execute cell change more frequently. This causes more signaling overhead in the air interference, and the network may perform more handover preparation of neighbor cells for CHO/CPAC.

Therefore, studies for mobility based on height in a wireless communication system are required.

Hereinafter, a method for mobility based on height in a wireless communication system, according to some embodiments of the present disclosure, will be described with reference to the following drawings.

The following drawings are created to explain specific embodiments of the present disclosure. The names of the specific devices or the names of the specific signals/messages/fields shown in the drawings are provided by way of example, and thus the technical features of the present disclosure are not limited to the specific names used in the following drawings. Herein, a wireless device may be referred to as a user equipment (UE).

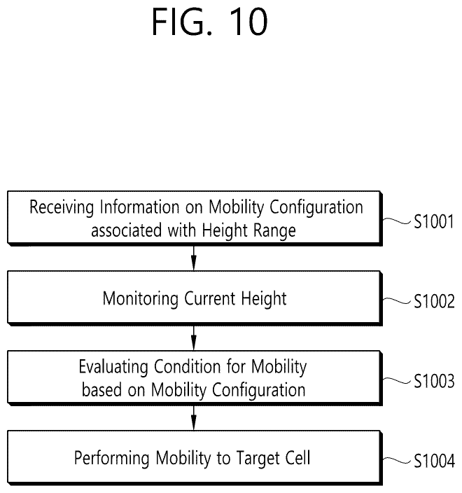

FIG. 10 shows an example of a method for mobility based on height in a wireless communication system, according to some embodiments of the present disclosure.

In particular, FIG. 10 shows an example of a method performed by a wireless device in a wireless communication system.

In step S1001, a wireless device may receive information on a mobility configuration associated with a height range.

For example, the mobility configuration may be a configuration for a conditional handover (CHO), a Conditional PSCell Addition/Change (CPAC), a cell selection procedure, and/or a cell reselection procedure.

For example, the information on the mobility configuration may include information on the height range to which the mobility configuration is applicable. For example, the information on the height range may include information on a maximum height, a minimum height, and/or a height boundary.

For example, the mobility configuration may include information on the one or more candidate target cells. The one or more candidate target cells may be valid while the wireless device being in the height range. For example, the one or more candidate target cells may be candidates for a CHO, a CPAC, a cell, a cell selection procedure, and/or a cell reselection procedure.

For example, the information on the mobility configuration may include information on a candidate target cell and information on a height range in which the candidate target cell is valid for the mobility.

For example, the height range may be set for each candidate target cell or set for each group of one or more candidate target cells.

For example, the height range may be configured per cell, per frequency, and/or per Radio Access Technology (RAT).

In step S1002, a wireless device may monitor a current height of the wireless device.

For example, the wireless device may determine a current height range among the plurality of height ranges based on the height of the wireless device.

The wireless device may apply a configuration associated with the current height range. For example, the configuration associated with the current height range may include a measurement configuration.

For example, when the current height range is different from the previous height range, the wireless device may apply a measurement configuration associated with the current height range. In other words, then the height range of the wireless device is changed, the wireless device may apply a configuration associated with the current height range.

In step S1003, a wireless device may evaluate at least one condition for a mobility based on the mobility configuration, based on the current height of the wireless device being in the height range.

For example, the mobility may be a conditional handover (CHO) and/or a Conditional PSCell Addition/Change (CPAC). In this case, the wireless device may determine whether the at least one condition for the CHO and/or the CPAC is satisfied, while the wireless device is in the height range. If the at least one condition is met, the wireless device may perform the CHO and/or the CPAC, as in the step S1004.

For example, the mobility may be a cell selection procedure and/or a cell reselection procedure. In this case, the wireless device may determine whether the at least one condition for cell selection and/or cell reselection is met, while the wireless device is in the height range. If the at least one condition is met, the wireless device may perform the cell selection and/or the cell reselection, as in step S1004. For example, the wireless device may select or reselect the target cell. The wireless device may camp on the target cell.

In step S1004, a wireless device may perform mobility to a target cell among one or more candidate target cells based on the evaluation.

For example, when the wireless device evaluates that one target cell satisfies the at least one condition, the wireless device may perform the mobility to the target cell.

For example, when the wireless device evaluates that two or more target cell satisfy the at least one condition, the wireless device may determine one target cell among the two or more target cells based on the mobility configuration. The wireless device may perform the mobility to the determined target cell.

According to some embodiments of the present disclosure, the information on the mobility configuration may include information on a first cell group of candidate target cells associated with a first height range and a second cell group of candidate target cells associated with a second height range.

Based on the current height of the wireless device being in the first height range, the wireless device may determine whether at least one condition for a mobility is satisfied only for the first cell group. The wireless device may perform the mobility to a cell included in the first cell group based on the at least one condition for the mobility being satisfied.

Based on the current height of the wireless device being in the first height range, the wireless device may determine whether at least one condition for a mobility is satisfied only for the first cell group. The wireless device may perform the mobility to a cell included in the second cell group based on the at least one condition for the mobility being satisfied.

For example, at least one cell could be included in both the first cell group and the second cell group.

In addition, for example, at least one cell could be included only one of the first cell group and the second cell group.

According to some embodiments of the present disclosure, the wireless device may be in communication with at least one of a user equipment, a network, or an autonomous vehicle other than the wireless device.

For example, the wireless device is a mobile device capable of vertical mobility.

Hereinafter, some embodiments of a method for mobility based on height in a wireless communication system are described.

The network may configure the allowed height for a target cell(s) at which reselection or conditional mobility can be executed. There are three options for configuring the allowed height.
1) The height may indicate the maximum height for a cell to allow reselection or execution of conditional mobility.
2) The height may indicate a minimum height for a cell to allow reselection or execution of conditional mobility.
3) The height may indicate a height boundary to allow reselection or execution of conditional mobility.

The target cell given for the allowed height may be indicated per cell, per frequency, or per RAT.

The allowed height may be set for each target cell or can be set by grouping several target cells.
1) The allowed height is configured per cell/frequency/RAT.
2) The allowed height is configured per group of several cells/frequencies/RATs.

If a cell/frequency/RAT is not configured an allowed height,
1) the cell/frequency/RAT may not be available in flight-mode, or
2) the cell/frequency/RAT will be available at any height.

The UE may perform reselection or conditional mobility for allowed cells/frequencies/RATs at the current height. There are some examples.

According to some embodiments of the present disclosure, a wireless device may receive a first configuration including mobility condition parameters. The mobility condition parameters may include cell reselection related params. The mobility condition parameters may include CHO related params including at least mobility execution and target cell configuration.

The wireless device may receive a second configuration including height information and applicable target cell information. The height information may indicate a list of height ranges. The applicable target cell information may indicate one or more target cells applicable in a given height range. The applicable target cell for the given range may be indicated per cell, per frequency, or per RAT.

The wireless device may determine a current height. The wireless device may evaluate a mobility condition to a target cell based on the first configuration, if the target cell is considered applicable in the current height. A target cell may be considered applicable if the target cell is applicable in the height range including the current height based on the second configuration.

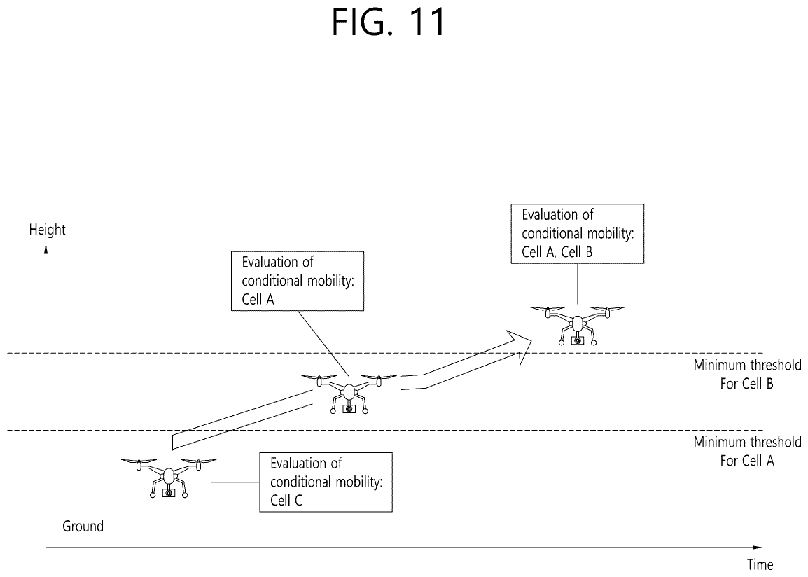

FIG. 11 shows an example of a method for a mobility based on height procedure in a wireless communication system, according to some embodiments of the present disclosure.

In particular, FIG. 11 illustrates a case of a conditional mobility with a minimum height threshold.

In FIG. 11, the minimum allowed height is configured for each cell/frequency/RAT. If height is not configured for a cell/frequency/RAT, the cell is not available in flight-mode. This example is for the cell. It could be replaced to frequency or RAT based on the network configuration.
(1) At the ground, the UE evaluates Cell C for a conditional mobility.
(2) When the aerial UE is in flight-mode, the UE stops evaluation of Cell C for conditional mobility and removes the Cell C from the evaluation list for conditional mobility.
(3) When the aerial UE is located at an altitude higher than the allowed height for Cell A, the UE adds the Cell A into the evaluation list for conditional mobility and starts evaluation of Cell A.
(4) When the aerial UE is located at an altitude higher than the allowed height for Cell B, the UE adds the cell B into the evaluation list for conditional mobility and starts evaluation of Cell B.

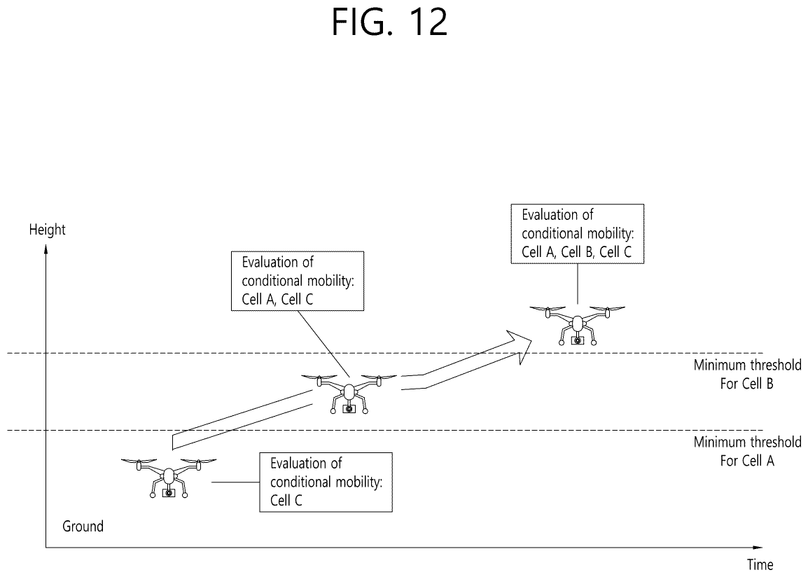

FIG. 12 shows an example of a method for a mobility based on height procedure in a wireless communication system, according to some embodiments of the present disclosure.

In particular, FIG. 12 illustrates a case of a conditional mobility with a minimum height threshold.

In FIG. 12, the minimum allowed height is configured for each cell/frequency/RAT. If height is not configured for a cell/frequency/RAT, the cell/frequency/RAT is available at any height. This example is for the cell. It may be replaced to frequency or RAT based on the network configuration.
(1) At the ground, the UE evaluates Cell C for a conditional mobility.
(2) When the aerial UE is located at an altitude higher than the allowed height for Cell A, the UE start evaluation Cell A for conditional mobility and adds the Cell A into the evaluation list for conditional mobility.
(3) When the aerial UE is located at an altitude higher than the allowed height for Cell B, the UE adds the cell B into the evaluation list for conditional mobility and starts evaluation Cell B.

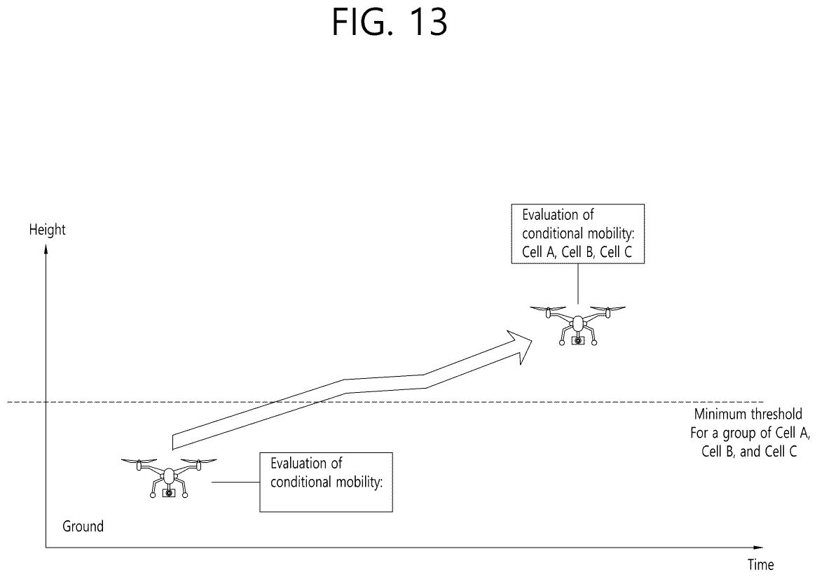

FIG. 13 shows an example of a method for a mobility based on height procedure in a wireless communication system, according to some embodiments of the present disclosure.

In particular, FIG. 13 illustrates a case of a conditional mobility with a minimum height threshold.

In FIG. 13, the minimum allowed height is configured for conditional mobility. That is, it affects all cells/frequencies/RATs of conditional mobility configuration. This example is for the cell. It may be replaced to frequency or RAT based on the network configuration.
(1) At the ground, the UE does not evaluate conditional mobility.
(2) When the aerial UE is located at an altitude higher than the allowed height for conditional mobility, the UE adds Cell A, Cell B, and Cell C into the evaluation list for conditional list and starts evaluation of Cell A, Cell B, and Cell C.

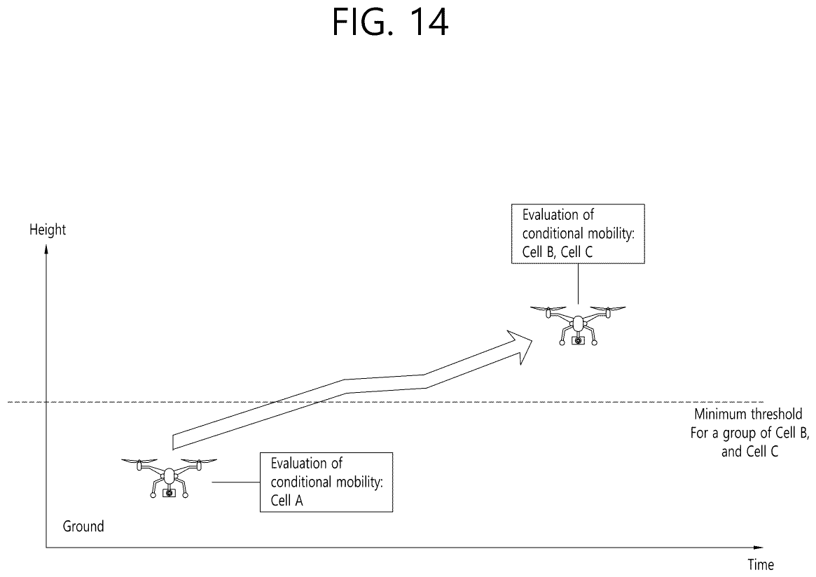

FIG. 14 shows an example of a method for a mobility based on height procedure in a wireless communication system, according to some embodiments of the present disclosure.

In particular, FIG. 14 illustrates a case of a conditional mobility with a minimum height threshold.

In FIG. 14, the minimum allowed height is configured for grouping several cells/frequencies/RATs among the cells/frequencies/RATs of conditional mobility. If a cell/frequency/RAT is not configured the group, the cell/frequency/RAT is not available in flight-mode. This example is for the cell. It may be replaced to frequency or RAT based on the network configuration.
(1) At the ground, the UE evaluates Cell A for a conditional mobility.
(2) When the aerial UE is in flight-mode, the UE stops evaluation of Cell A for conditional mobility and removes the Cell A from the evaluation list for conditional mobility.
(3) When the aerial UE is located at an altitude higher than the allowed height for a group (Cell B/Cell C) for conditional mobility, the UE adds Cell B and Cell C into the evaluation list for conditional mobility starts evaluation of Cell B and Cell C.

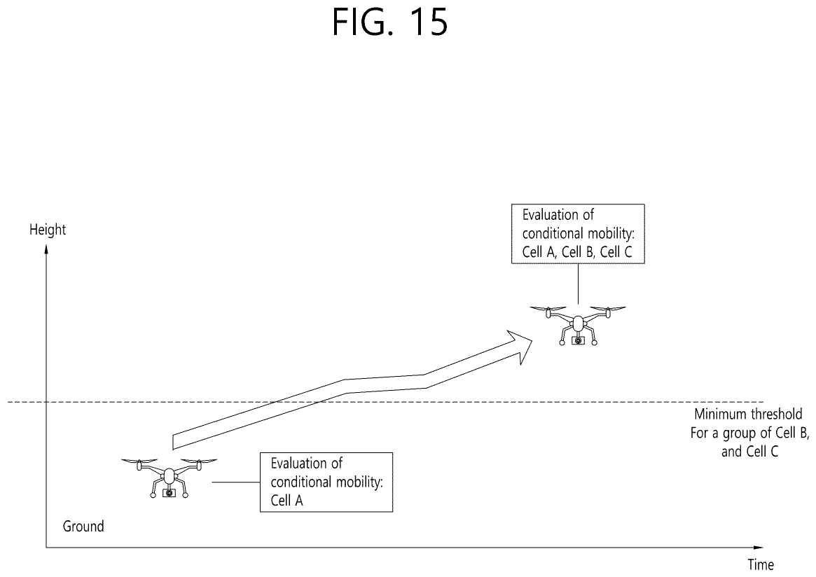

FIG. 15 shows an example of a method for a mobility based on height procedure in a wireless communication system, according to some embodiments of the present disclosure.

In particular, FIG. 15 illustrates a case of a conditional mobility with a minimum height threshold.

In FIG. 15, the minimum allowed height is configured for grouping several cells/frequencies/RATs among the cells/frequencies/RATs of conditional mobility. If a cell/frequency/RAT is not configured the group, the cell/frequency/RAT is available at any height. This example is for the cell. It may be replaced to frequency or RAT based on the network configuration.
(1) At the ground, the UE evaluates Cell A for a conditional mobility.
(2) When the aerial UE is located at an altitude higher than the allowed height for a group (Cell B/Cell C) for conditional mobility, the UE adds Cell A, Cell B, and Cell C into the evaluation list for conditional mobility and starts evaluation of Cell A, Cell B, and Cell C.

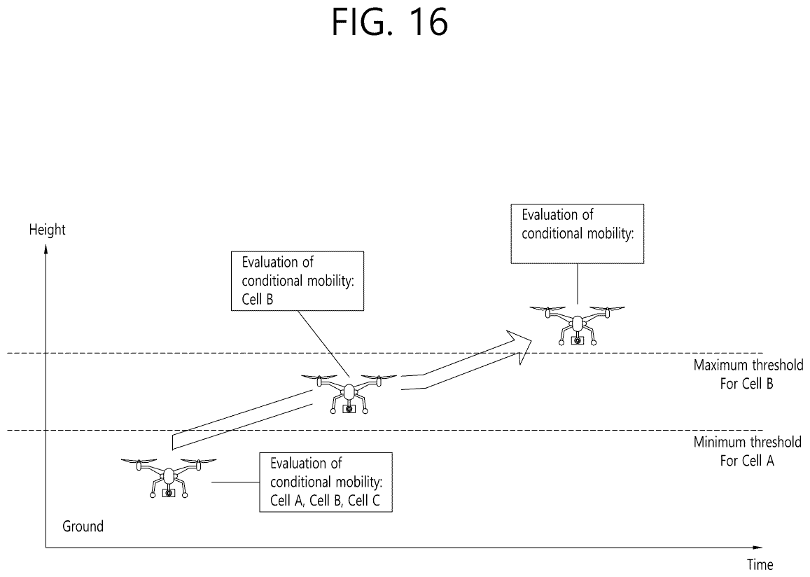

FIG. 16 shows an example of a method for a mobility based on height procedure in a wireless communication system, according to some embodiments of the present disclosure.

In particular, FIG. 16 illustrates a case of a conditional mobility with a maximum height threshold.

In FIG. 16, the maximum allowed height is configured for each cell/frequency/RAT. If height is not configured for a cell/frequency/RAT, the cell/frequency/RAT is not available in flight-mode. This example is for the cell. It may be replaced to frequency or RAT based on the network configuration.
(1) At the ground, the UE evaluates Cell A, Cell B, and Cell C for conditional mobility.
(2) When the aerial UE is in flight-mode, the UE stops evaluation of Cell C for conditional mobility and removes the Cell C from the evaluation list for conditional mobility.
(3) When the aerial UE is located at an altitude higher than the allowed height for Cell A, the UE stops evaluation of Cell A for conditional mobility and removes the Cell A from the evaluation list for conditional mobility.
(4) When the aerial UE is located at an altitude higher than the allowed height for Cell B, the UE stops evaluation of Cell B for conditional mobility and removes the cell B from the evaluation list for conditional mobility.

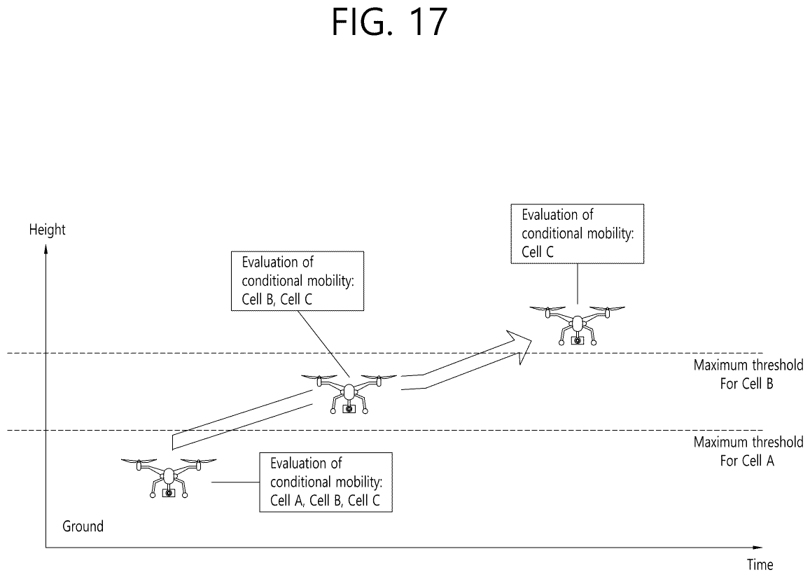

FIG. 17 shows an example of a method for a mobility based on height procedure in a wireless communication system, according to some embodiments of the present disclosure.

In particular, FIG. 17 illustrates a case of a conditional mobility with a maximum height threshold.

In FIG. 17, the maximum allowed height is configured for each cell/frequency/RAT. If height is not configured for a cell/frequency/RAT, the cell/frequency/RAT is available at any height. This example is for the cell. It may be replaced to frequency or RAT based on the network configuration.
(1) At the ground, the UE evaluates Cell A, Cell B, and Cell C for a conditional mobility.
(2) When the aerial UE is located at an altitude higher than the allowed height for Cell A, the UE stops evaluation of Cell A for conditional mobility and removes the Cell A from the evaluation list for conditional mobility.
(3) When the aerial UE is located at an altitude higher than the allowed height for Cell B, the UE stops evaluation of Cell B for conditional mobility and removes the cell B from the evaluation list for conditional mobility.

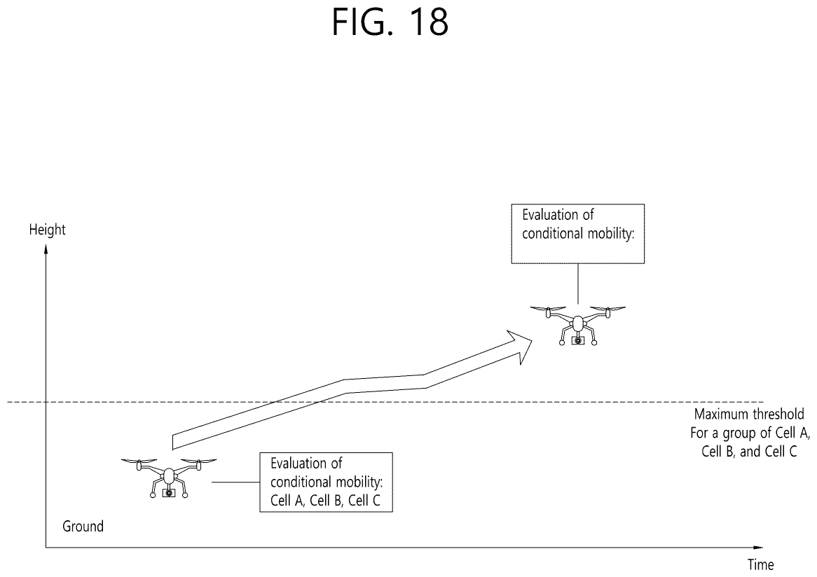

FIG. 18 shows an example of a method for a mobility based on height procedure in a wireless communication system, according to some embodiments of the present disclosure.

In particular, FIG. 18 illustrates a case of a conditional mobility with a maximum height threshold.

In FIG. 18, the maximum allowed height is configured for conditional mobility. That is, it affects all cells/frequencies/RATs of conditional mobility configuration. This example is for the cell. It may be replaced to frequency or RAT based on the network configuration.
(1) At the ground, the UE evaluates Cell A, Cell B, and Cell C for conditional mobility.
(2) When the aerial UE is located at an altitude higher than the allowed height for conditional mobility, the UE stops evaluation of Cell A, Cell B, and Cell C for conditional mobility and removes Cell A, Cell B, and Cell C from the evaluation list for conditional mobility.

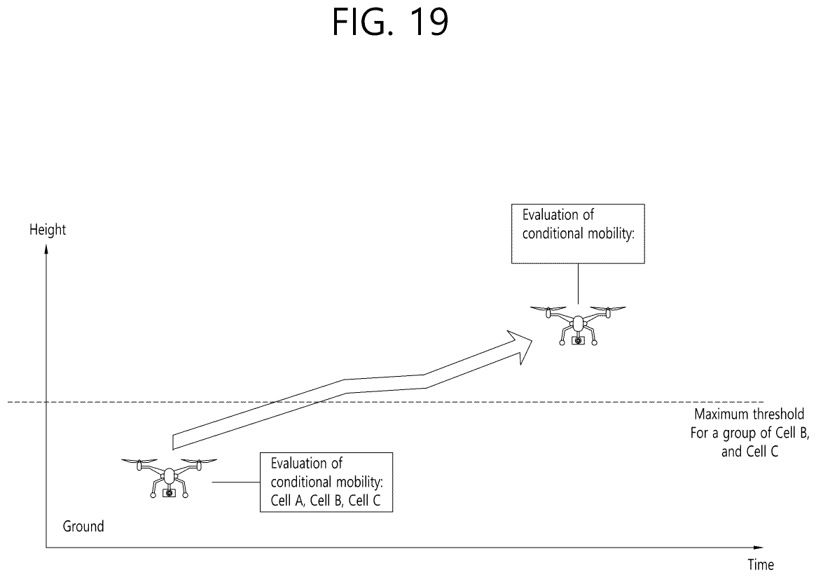

FIG. 19 shows an example of a method for a mobility based on height procedure in a wireless communication system, according to some embodiments of the present disclosure.

In particular, FIG. 19 illustrates a case of a conditional mobility with a maximum height threshold.

In FIG. 19, the minimum allowed height is configured for grouping several cells/frequencies/RATs among the cells/frequencies/RATs of conditional mobility. If a cell/frequency/RAT is not configured the group, the cell/frequency/RAT is not available in flight-mode. This example is for the cell. It may be replaced to frequency or RAT based on the network configuration.
(1) At the ground, the UE evaluates Cell A, Cell B, and Cell C for conditional mobility.
(2) When the aerial UE is in flight-mode, the UE stops evaluation of Cell A for conditional mobility and removes the Cell A from the evaluation list for conditional mobility.
(3) When the aerial UE is located at an altitude higher than the allowed height for a group (Cell B/Cell C) for conditional mobility, the UE stops evaluation of Cell B, and Cell C for conditional mobility and removes Cell B and Cell C from the evaluation list for conditional mobility.

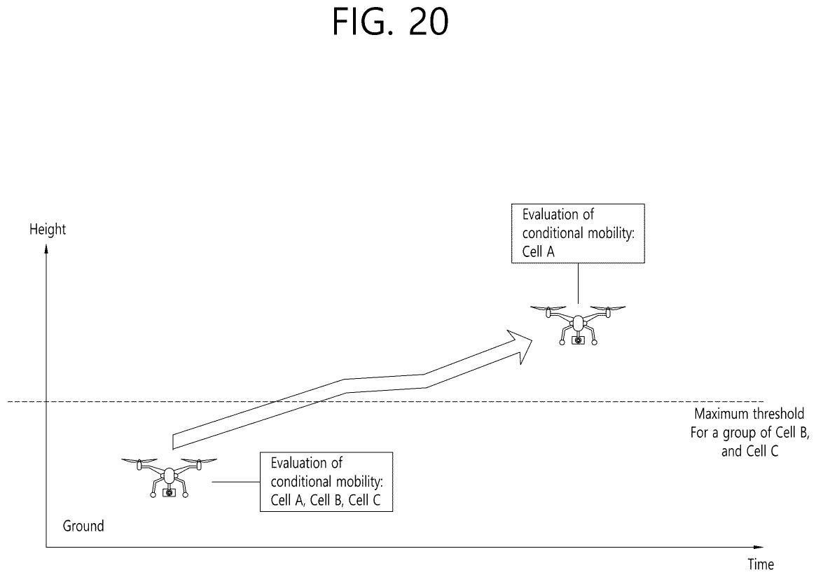

FIG. 20 shows an example of a method for a mobility based on height procedure in a wireless communication system, according to some embodiments of the present disclosure.

In particular, FIG. 20 illustrates a case of a conditional mobility with a maximum height threshold.

In FIG. 20, the minimum allowed height is configured for grouping several cells/frequencies/RATs among the cells/frequencies/RATs of conditional mobility. If a cell/frequency/RAT is not configured the group, the cell/frequency/RAT is available at any height. This example is for the cell. It may be replaced to frequency or RAT based on the network configuration.
(1) At the ground, the UE evaluates Cell A, Cell B, and Cell C for conditional mobility.
(2) When the aerial UE is located at an altitude higher than the allowed height for a group (Cell B/Cell C) for conditional mobility, the UE stops evaluation of Cell B, and Cell C for conditional mobility and removes Cell B and Cell C from the evaluation list for conditional mobility.

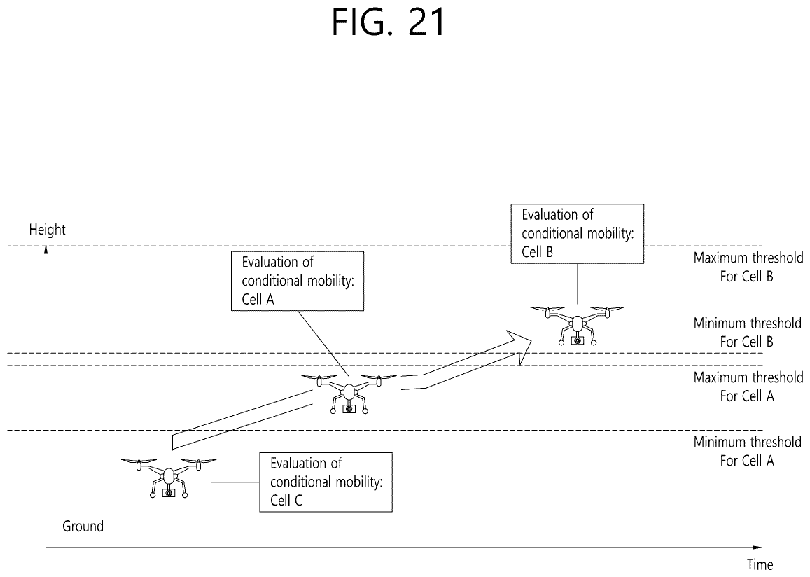

FIG. 21 shows an example of a method for a mobility based on height procedure in a wireless communication system, according to some embodiments of the present disclosure.

In particular, FIG. 21 illustrates a case of a conditional mobility with a height boundary.

In FIG. 21, the maximum allowed height and minimum allowed height are configured for each cell/frequency/RAT. If height is not configured for a cell/frequency/RAT, the cell/frequency/RAT is not available in flight-mode. This example is for the cell. It may be replaced to frequency or RAT based on the network configuration.
(1) At the ground, the UE evaluates Cell C for conditional mobility.
(2) When the aerial UE is in flight-mode, the UE stops evaluation of Cell C for conditional mobility and removes the Cell C from the evaluation list for conditional mobility.
(3) When the aerial UE is located at an altitude higher than the minimum allowed height for Cell A, the UE adds the Cell A into the evaluation list for conditional mobility and starts evaluation Cell A.
(4) When the aerial UE is located at an altitude higher than the maximum allowed height for Cell A, the UE stops evaluation of Cell A for conditional mobility and removes the Cell A from the evaluation list for conditional mobility.
(5) When the aerial UE is located at an altitude higher than the minimum allowed height for Cell B, the UE adds the Cell B into the evaluation list for conditional mobility and starts evaluation Cell B.
(6) When the aerial UE is located at an altitude higher than the maximum allowed height for Cell B, the UE stops evaluation of Cell B for conditional mobility and removes the cell B from the evaluation list for conditional mobility.

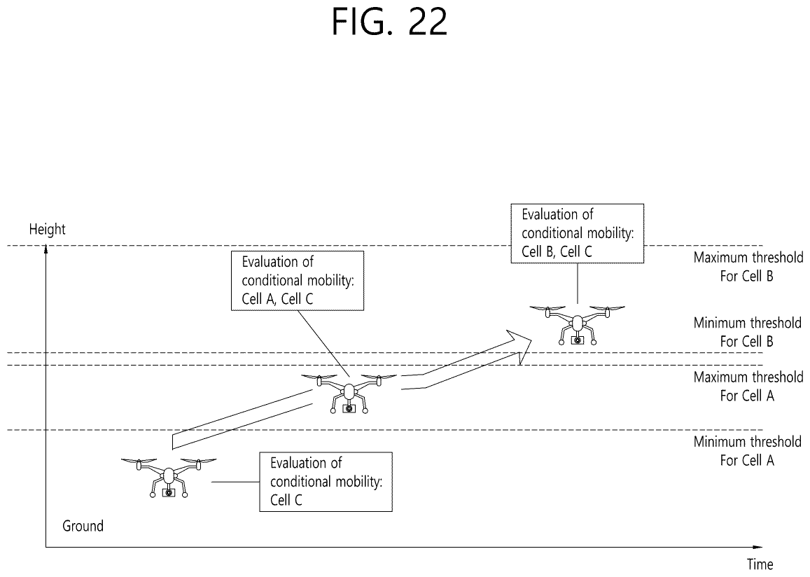

FIG. 22 shows an example of a method for a mobility based on height procedure in a wireless communication system, according to some embodiments of the present disclosure.

In particular, FIG. 22 illustrates a case of a conditional mobility with a height boundary.

In FIG. 22, the maximum allowed height and minimum allowed height are configured for each cell/frequency/RAT. If height is not configured for a cell/frequency/RAT, the cell/frequency/RAT is available at any height. This example is for the cell. It may be replaced to frequency or RAT based on the network configuration.
(1) At the ground, the UE evaluates Cell C for conditional mobility.
(2) When the aerial UE is located at an altitude higher than the minimum allowed height for Cell A, the UE adds the Cell A into the evaluation list for conditional mobility and starts evaluation Cell A for conditional mobility.
(3) When the aerial UE is located at an altitude higher than the allowed height for Cell A, the UE stops evaluation of Cell A for conditional mobility and removes the Cell A from the evaluation list for conditional mobility.
(4) When the aerial UE is located at an altitude higher than the minimum allowed height for Cell B, the UE adds the Cell B into the evaluation list for conditional mobility and starts evaluation Cell B.
(5) When the aerial UE is located at an altitude higher than the allowed height for Cell B, the UE stops evaluation of Cell B for conditional mobility and removes the cell B from the evaluation list for conditional mobility.

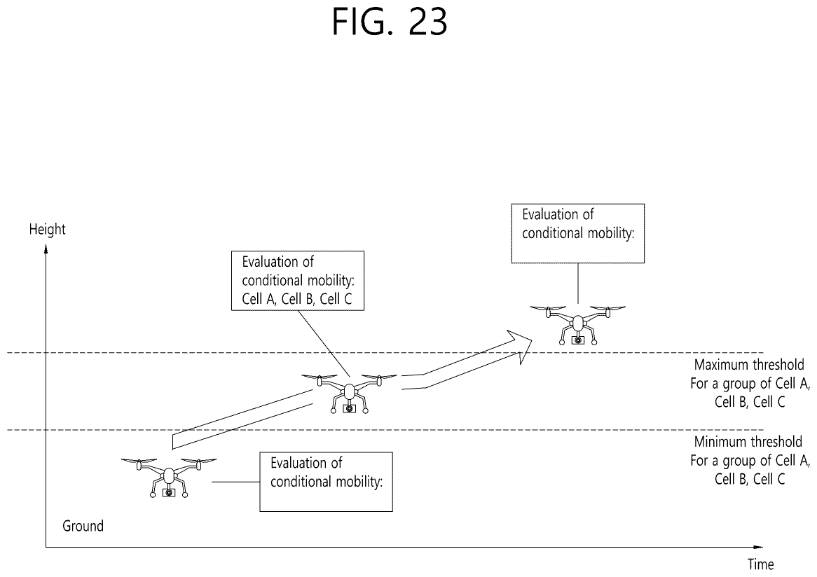

FIG. 23 shows an example of a method for a mobility based on height procedure in a wireless communication system, according to some embodiments of the present disclosure.

In particular, FIG. 23 illustrates a case of a conditional mobility with a height boundary.

In FIG. 23, the maximum allowed height and minimum allowed height are configured for conditional mobility. That is, it affects all cells/frequencies/RATs of conditional mobility configuration. This example is for the cell. It may be replaced to frequency or RAT based on the network configuration.
(1) At the ground, the UE does not evaluate conditional mobility.
(2) When the aerial UE is located at an altitude higher than the minimum allowed height for conditional mobility, the UE adds Cell A, Cell B, and Cell C into the evaluation list for conditional mobility and starts evaluation of Cell A, Cell B, and Cell C.
(3) When the aerial UE is located at an altitude higher than the maximum allowed height for conditional mobility, the UE stops evaluation of Cell A, Cell B, and Cell C for conditional mobility and removes the Cell A, Cell B, and Cell C from the evaluation list for conditional mobility.

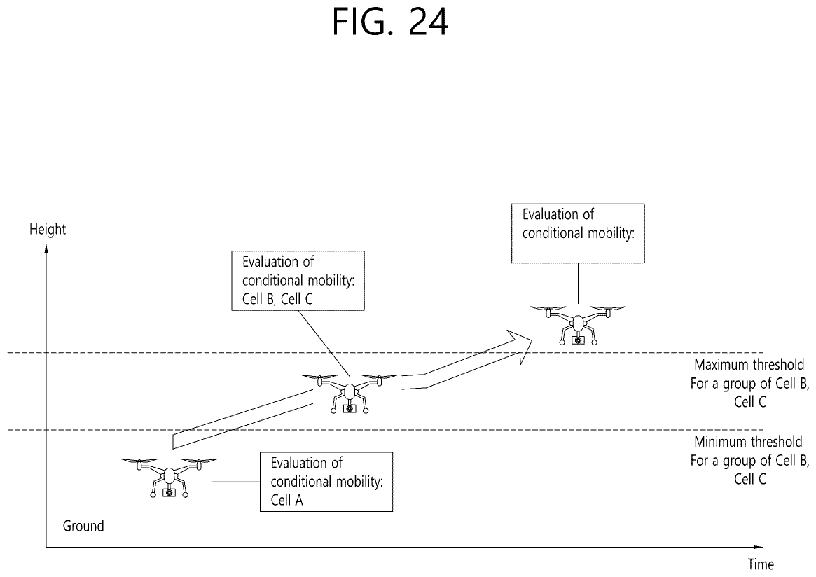

FIG. 24 shows an example of a method for a mobility based on height procedure in a wireless communication system, according to some embodiments of the present disclosure.

In particular, FIG. 24 illustrates a case of a conditional mobility with a height boundary.

In FIG. 24, the maximum allowed height and minimum allowed height are configured for grouping several cells/frequencies/RATs among the cells of conditional mobility. If a cell/frequency/RAT is not configured the group, the cell/frequency/RAT is not available in flight-mode. This example is for the cell. It may be replaced to frequency or RAT based on the network configuration.
(1) At the ground, the UE evaluates Cell A for conditional mobility.
(2) When the aerial UE is in flight-mode, the UE stops evaluation of Cell A for conditional mobility and removes the Cell A from the evaluation list for conditional mobility because it is not available in flight-mode.
(3) When the aerial UE is located at an altitude higher than the minimum allowed height for a group (Cell B/Cell C) for conditional mobility, the UE adds Cell B and Cell C into the evaluation list for conditional mobility and starts evaluation of Cell B and Cell C.
(4) When the aerial UE is located at an altitude higher than the maximum allowed height for a group (Cell B/Cell C) for conditional mobility, the UE stops evaluation of Cell B, and Cell C for conditional mobility and remove Cell B and Cell C from the evaluation list of conditional mobility.

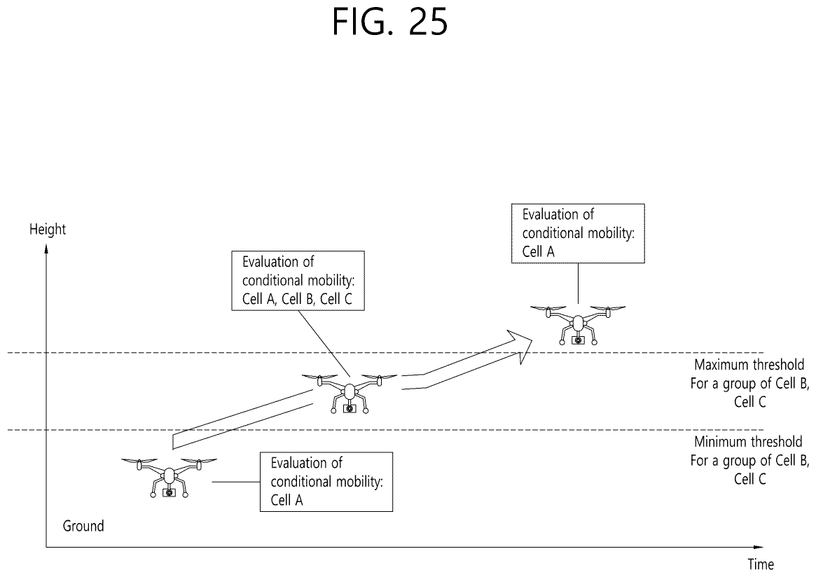

FIG. 25 shows an example of a method for a mobility based on height procedure in a wireless communication system, according to some embodiments of the present disclosure.

In particular, FIG. 25 illustrates a case of a conditional mobility with a height boundary.

In FIG. 25, the maximum allowed height and minimum allowed height are configured for grouping several cells/frequencies/RATs among the cells of conditional mobility. If a cell/frequency/RAT is not configured the group, the cell/frequency/RAT is available at any height. This example is for the cell. It may be replaced to frequency or RAT based on the network configuration.
(1) At the ground, the UE evaluates Cell A for conditional mobility.
(2) When the aerial UE is located at an altitude higher than the minimum allowed height for a group (Cell B/Cell C) for conditional mobility, the UE adds Cell B and Cell C into the evaluation list for conditional mobility and starts evaluation of Cell B, and Cell C.
(3) When the aerial UE is located at an altitude higher than the maximum allowed height for a group (Cell B/Cell C) for conditional mobility, the UE stops evaluation of Cell B, and Cell C for conditional mobility and remove Cell B and Cell C from the evaluation list of conditional mobility.

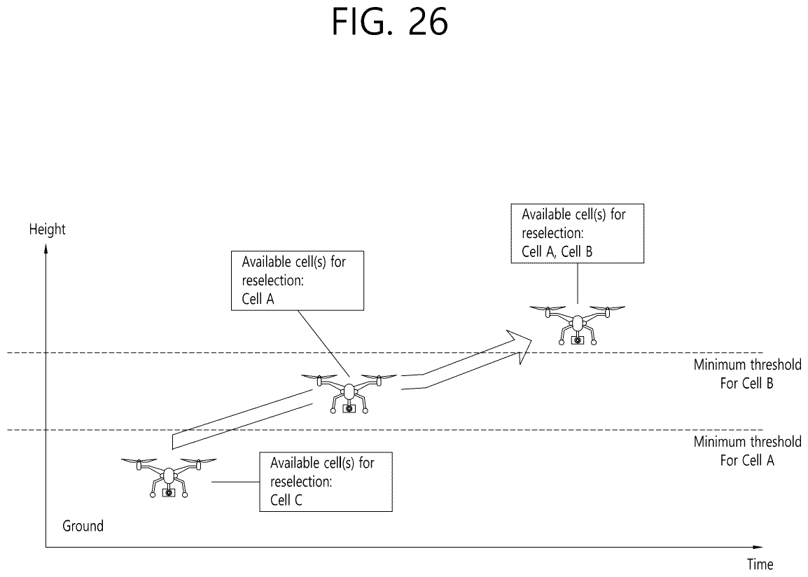

FIG. 26 shows an example of a method for a mobility based on height procedure in a wireless communication system, according to some embodiments of the present disclosure.

In particular, FIG. 26 illustrates a case of a reselection with a minimum height threshold.

In FIG. 26, the minimum allowed height is configured for each cell/frequency/RAT. If height is not configured for a cell/frequency/RAT, the cell/frequency/RAT is not available in flight-mode. This example is for the cell. It may be replaced to frequency or RAT based on the network configuration.
(1) At the ground, the UE evaluates Cell C for a reselection.
(2) When the aerial UE is in flight-mode, the UE cannot reselect to Cell C.
(3) When the aerial UE is located at an altitude higher than the allowed height for Cell A, the UE can reselect to Cell A based on the reselection criteria.
(4) When the aerial UE is located at an altitude higher than the allowed height for Cell B, the UE can reselect to Cell B based on the reselection criteria.

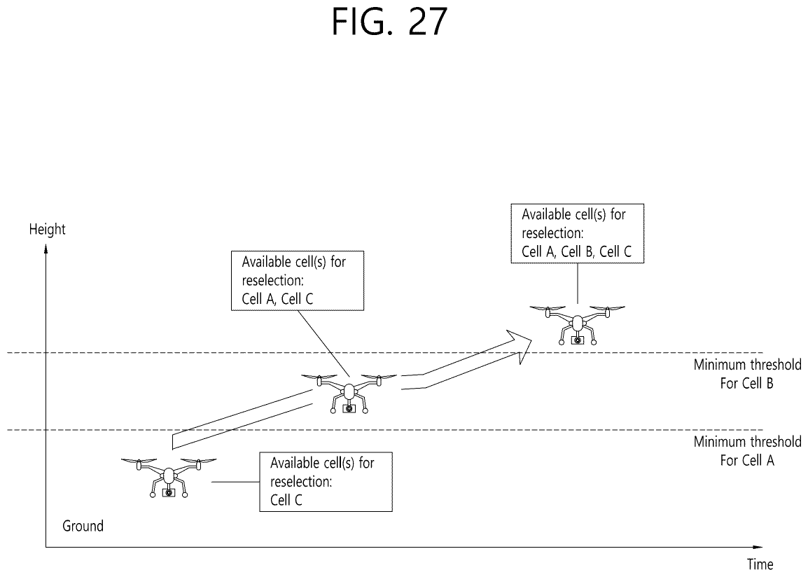

FIG. 27 shows an example of a method for a mobility based on height procedure in a wireless communication system, according to some embodiments of the present disclosure.

In particular, FIG. 27 illustrates a case of a reselection with a minimum height threshold.

In FIG. 27, the minimum allowed height is configured for each cell/frequency/RAT. If height is not configured for a cell/frequency/RAT, the cell/frequency/RAT is available at any height. This example is for the cell. It may be replaced to frequency or RAT based on the network configuration.
(1) At the ground, the UE evaluates Cell C for a reselection.
(2) When the aerial UE is located at an altitude higher than the allowed height for Cell A, the UE can reselect to Cell A based on the reselection criteria.
(3) When the aerial UE is located at an altitude higher than the allowed height for Cell B, the UE can reselect to Cell B based on the reselection criteria.

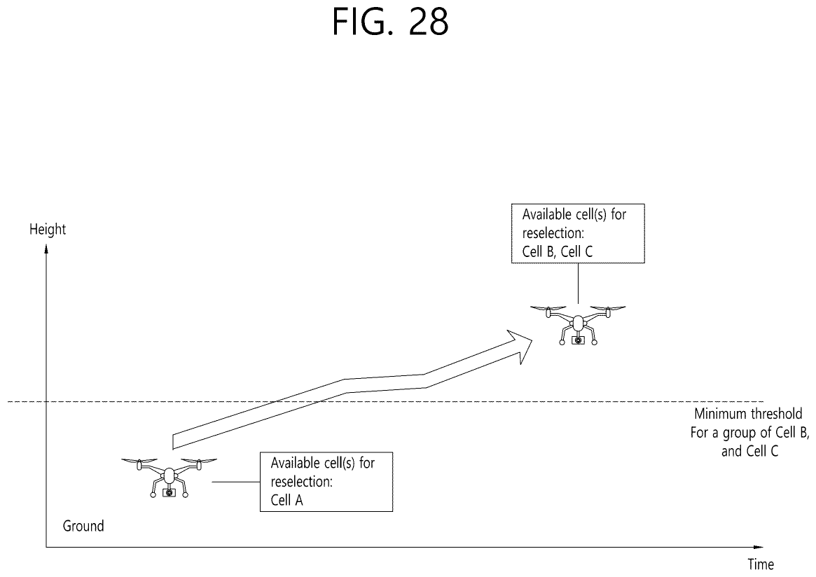

FIG. 28 shows an example of a method for a mobility based on height procedure in a wireless communication system, according to some embodiments of the present disclosure.

In particular, FIG. 28 illustrates a case of a reselection with a minimum height threshold.

In FIG. 28, the minimum allowed height is configured for grouping several cells/frequencies/RATs among the cells/frequencies/RATs of conditional mobility. If a cell/frequency/RAT is not configured the group, the cell/frequency/RAT is not available in flight-mode. This example is for the cell. It may be replaced to frequency or RAT based on the network configuration.
(1) At the ground, the UE evaluates Cell A for a reselection.
(2) When the aerial UE is in flight-mode, the UE cannot reselect to Cell A.
(3) When the aerial UE is located at an altitude higher than the allowed height for a group (Cell B/Cell C) for reselection, the UE can reselect Cell B or Cell C based on the reselection criteria.

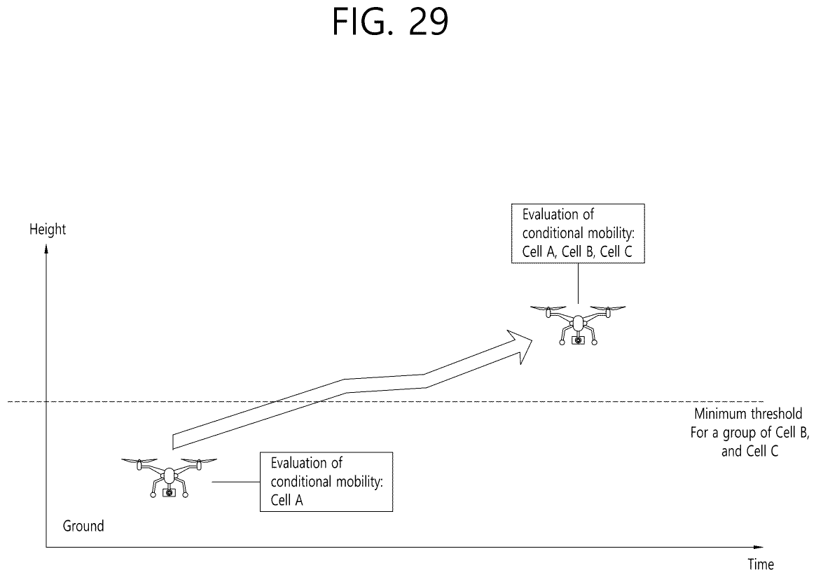

FIG. 29 shows an example of a method for a mobility based on height procedure in a wireless communication system, according to some embodiments of the present disclosure.

In particular, FIG. 29 illustrates a case of a reselection with a minimum height threshold.

In FIG. 29, the minimum allowed height is configured for grouping several cells/frequencies/RATs among the cells/frequencies/RATs of conditional mobility. If a cell/frequency/RAT is not configured the group, the cell/frequency/RAT is available at any height. This example is for the cell. It may be replaced to frequency or RAT based on the network configuration.
(1) At the ground, the UE evaluates Cell A for a reselection.
(2) When the aerial UE is located at an altitude higher than the allowed height for a group (Cell B/Cell C) for reselection, the UE can reselect Cell A, Cell B, or Cell C based on the reselection criteria.

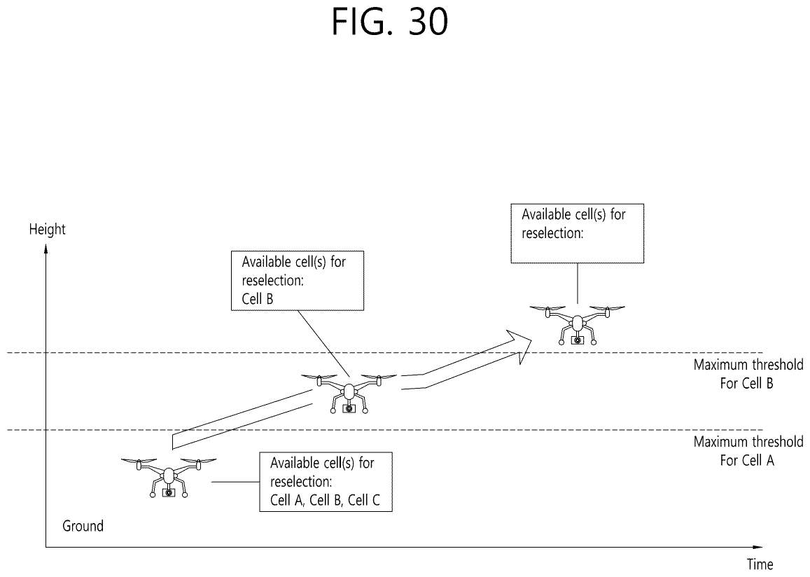

FIG. 30 shows an example of a method for a mobility based on height procedure in a wireless communication system, according to some embodiments of the present disclosure.

In particular, FIG. 30 illustrates a case of a reselection with a maximum height threshold.

In FIG. 30, the maximum allowed height is configured for each cell/frequency/RAT. If height is not configured for a cell/frequency/RAT, the cell/frequency/RAT is not available in flight-mode. This example is for the cell. It may be replaced to frequency or RAT based on the network configuration.
(1) At the ground, the UE evaluates Cell A, Cell B, and Cell C for a reselection.
(2) When the aerial UE is in flight-mode, the UE cannot reselect to Cell C.
(3) When the aerial UE is located at an altitude higher than the allowed height for Cell A, the UE cannot reselect to Cell A.
(4) When the aerial UE is located at an altitude higher than the allowed height for Cell B, the UE cannot reselect to Cell B.

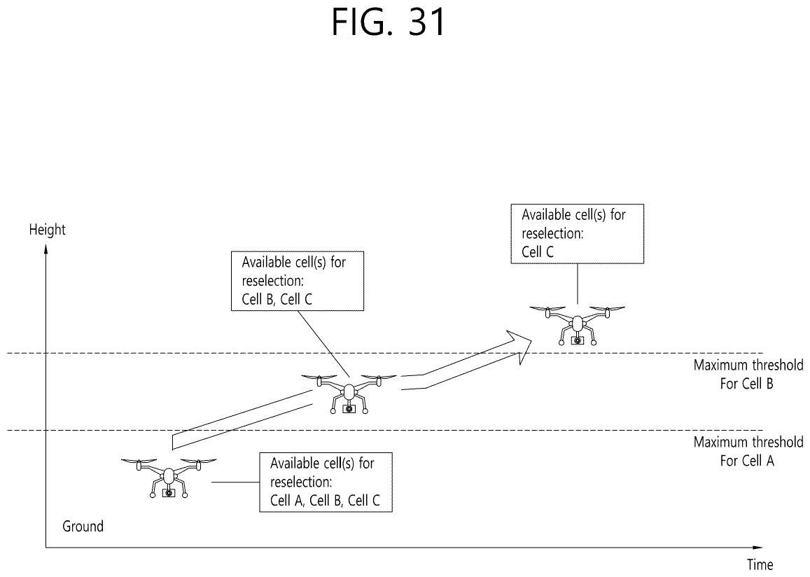

FIG. 31 shows an example of a method for a mobility based on height procedure in a wireless communication system, according to some embodiments of the present disclosure.

In particular, FIG. 31 illustrates a case of a reselection with a maximum height threshold.

In FIG. 31, the maximum allowed height is configured for each cell/frequency/RAT. If height is not configured for a cell/frequency/RAT, the cell/frequency/RAT is available at any height. This example is for the cell. It may be replaced to frequency or RAT based on the network configuration.
(1) At the ground, the UE evaluates Cell A, Cell B, and Cell C for a reselection.
(2) When the aerial UE is located at an altitude higher than the allowed height for Cell A, the UE cannot reselect to Cell A.
(3) When the aerial UE is located at an altitude higher than the allowed height for Cell B, the UE cannot reselect to Cell B.

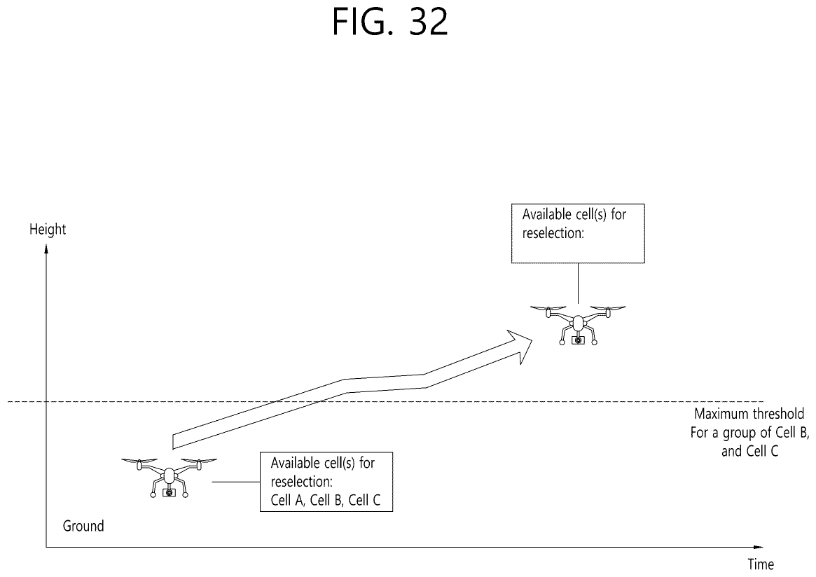

FIG. 32 shows an example of a method for a mobility based on height procedure in a wireless communication system, according to some embodiments of the present disclosure.

In particular, FIG. 32 illustrates a case of a reselection with a maximum height threshold.

In FIG. 32, the minimum allowed height is configured for grouping several cells/frequencies/RATs among the cells/frequencies/RATs of conditional mobility. If a cell/frequency/RAT is not configured the group, the cell/frequency/RAT is not available in flight-mode. This example is for the cell. It may be replaced to frequency or RAT based on the network configuration.
(1) At the ground, the UE evaluates Cell A, Cell B, and Cell C for a reselection.
(2) When the aerial UE is in flight-mode, the UE cannot reselect to Cell A.
(3) When the aerial UE is located at an altitude higher than the allowed height for a group (Cell B/Cell C) for reselection, the UE cannot reselect to Cell B and Cell C.

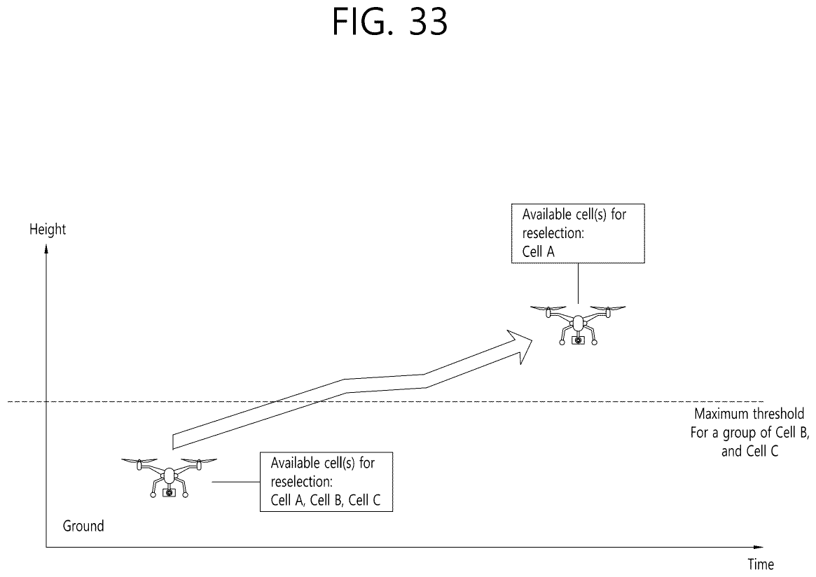

FIG. 33 shows an example of a method for a mobility based on height procedure in a wireless communication system, according to some embodiments of the present disclosure.

In particular, FIG. 33 illustrates a case of a reselection with a maximum height threshold.

In FIG. 33, the minimum allowed height is configured for grouping several cells/frequencies/RATs among the cells/frequencies/RATs of conditional mobility. If a cell/frequency/RAT is not configured the group, the cell/frequency/RAT is available at any height. This example is for the cell. It may be replaced to frequency or RAT based on the network configuration.
(1) At the ground, the UE evaluates Cell A, Cell B, and Cell C for a reselection.
(2) When the aerial UE is located at an altitude higher than the allowed height for a group (Cell B/Cell C) for reselection, the UE cannot reselect to Cell B and Cell C.

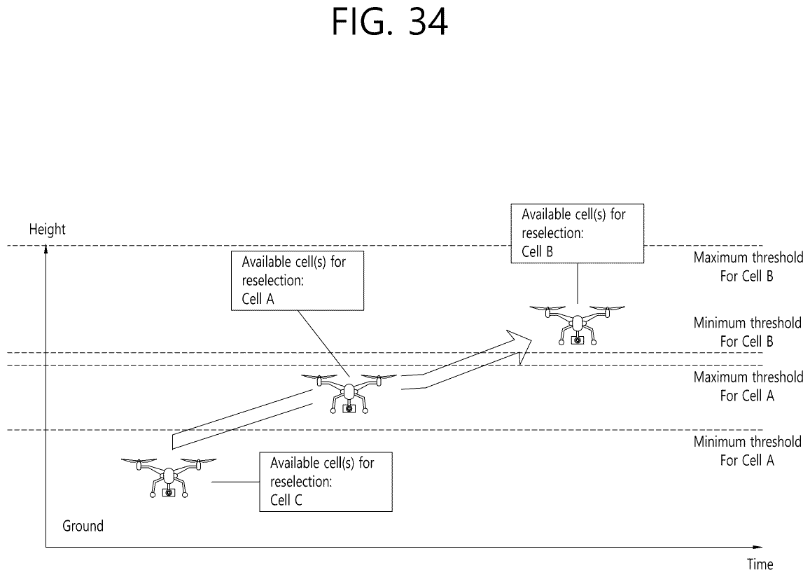

FIG. 34 shows an example of a method for a mobility based on height procedure in a wireless communication system, according to some embodiments of the present disclosure.

In particular, FIG. 34 illustrates a case of a reselection with a height boundary.

In FIG. 34, the maximum allowed height and minimum allowed height are configured for each cell/frequency/RAT. If height is not configured for a cell/frequency/RAT, the cell/frequency/RAT is not available in flight-mode. This example is for the cell. It may be replaced to frequency or RAT based on the network configuration.
(1) At the ground, the UE evaluates Cell C for a reselection.
(2) When the aerial UE is in flight-mode, the UE cannot reselect to Cell C.
(3) When the aerial UE is located at an altitude higher than the minimum allowed height for Cell A, the UE can reselect to Cell A based on the reselection criteria.
(4) When the aerial UE is located at an altitude higher than the maximum allowed height for Cell A, the UE cannot reselect to Cell A.
(5) When the aerial UE is located at an altitude higher than the minimum allowed height for Cell B, the UE can reselect to Cell B based on the reselection criteria.
(6) When the aerial UE is located at an altitude higher than the maximum allowed height for Cell B, the UE cannot reselect to Cell B.

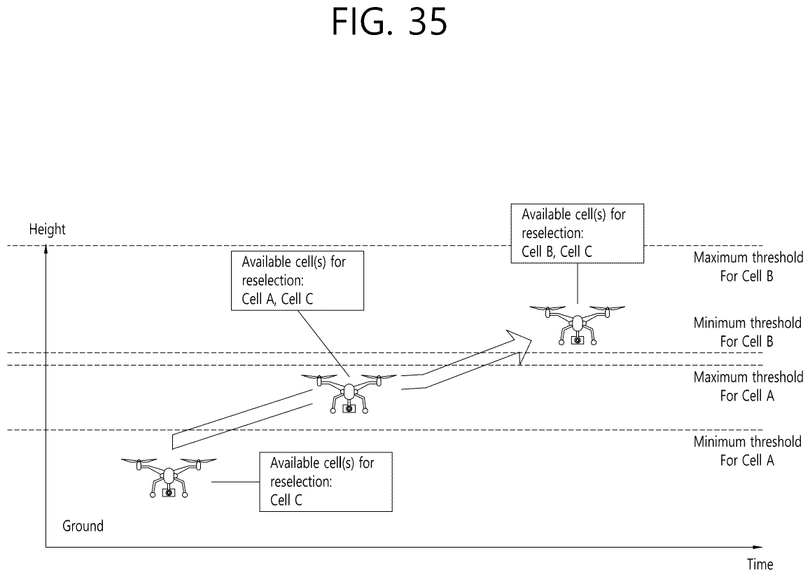

FIG. 35 shows an example of a method for a mobility based on height procedure in a wireless communication system, according to some embodiments of the present disclosure.

In particular, FIG. 35 illustrates a case of a reselection with a height boundary.

In FIG. 35, the maximum allowed height and minimum allowed height are configured for each cell/frequency/RAT. If height is not configured for a cell/frequency/RAT, the cell/frequency/RAT is available at any height. This example is for the cell. It may be replaced to frequency or RAT based on the network configuration.
(1) At the ground, the UE evaluates Cell C for a reselection.
(2) When the aerial UE is located at an altitude higher than the minimum allowed height for Cell A, the UE can reselect to Cell A based on the reselection criteria.
(3) When the aerial UE is located at an altitude higher than the allowed height for Cell A, the UE cannot reselect to Cell A.
(4) When the aerial UE is located at an altitude higher than the minimum allowed height for Cell B, the UE can reselect to Cell B based on the reselection criteria.
(5) When the aerial UE is located at an altitude higher than the allowed height for Cell B, the UE cannot reselect to Cell B.

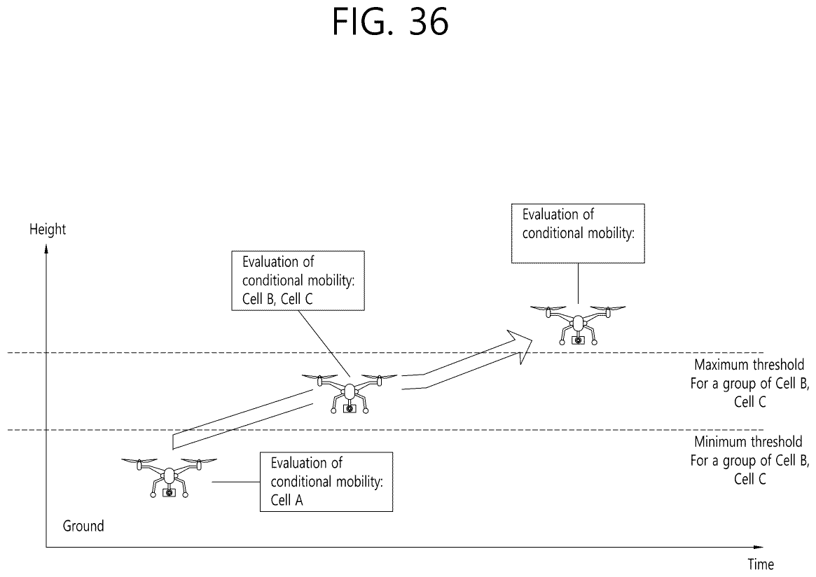

FIG. 36 shows an example of a method for a mobility based on height procedure in a wireless communication system, according to some embodiments of the present disclosure. In particular, FIG. 36 illustrates a case of a reselection with a height boundary.

In FIG. 36, the maximum allowed height and minimum allowed height are configured for grouping several cells/frequencies/RATs among the cells/frequencies/RATs of conditional mobility. If a cell/frequency/RAT is not configured the group, the cell/frequency/RAT is not available in flight-mode. This example is for the cell. It may be replaced to frequency or RAT based on the network configuration.
(1) At the ground, the UE evaluates Cell A for a reselection.
(2) When the aerial UE is in flight-mode, the UE cannot reselect to Cell A.
(3) When the aerial UE is located at an altitude higher than the minimum allowed height for a group (Cell B/Cell C) for reselection, the UE can reselect Cell B or Cell C based on the reselection criteria.
(4) When the aerial UE is located at an altitude higher than the maximum allowed height for a group (Cell B/Cell C) for reselection, the UE cannot reselect to Cell B and Cell C.

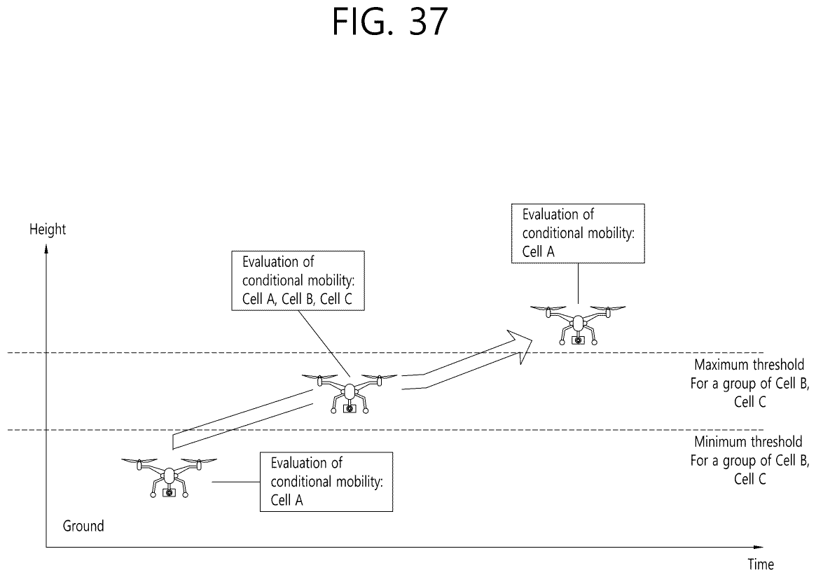

FIG. 37 shows an example of a method for a mobility based on height procedure in a wireless communication system, according to some embodiments of the present disclosure.

In particular, FIG. 37 illustrates a case of a reselection with a height boundary.

In FIG. 37, the maximum allowed height and minimum allowed height are configured for grouping several cells/frequencies/RATs among the cells of conditional mobility. If a cell/frequency/RAT is not configured the group, the cell/frequency/RAT is available at any height. This example is for the cell. It may be replaced to frequency or RAT based on the network configuration.
(1) At the ground, the UE evaluates Cell A for conditional mobility.
(2) When the aerial UE is located at an altitude higher than the minimum allowed height for a group (Cell B/Cell C) for reselection, the UE can reselect Cell B or Cell C based on the reselection criteria.
(3) When the aerial UE is located at an altitude higher than the maximum allowed height for a group (Cell B/Cell C) for reselection, the UE cannot reselect to Cell B and Cell C.

Some of the detailed steps shown in the examples of FIGS. 10-37 may not be essential steps and may be omitted. In addition to the steps shown in FIGS. 10-37, other steps may be added, and the order of the steps may vary. Some of the above steps may have their own technical meaning.

Hereinafter, an apparatus for mobility based on height in a wireless communication system, according to some embodiments of the present disclosure, will be described. Herein, the apparatus may be a wireless device (100 or 200) in FIGS. 2, 3, and 5.

For example, a wireless device may perform the methods described above. The detailed description overlapping with the above-described contents could be simplified or omitted.

Referring to FIG. 5, a wireless device 100 may include a processor 102, a memory 104, and a transceiver 106.

According to some embodiments of the present disclosure, the processor 102 may be configured to be coupled operably with the memory 104 and the transceiver 106.

The processor 102 may be configured to control the transceiver 106 to receive information on a mobility configuration associated with a height range. The processor 102 may be configured to monitor a current height of the wireless device. The processor 102 may be configured to evaluate at least one condition for a mobility based on the mobility configuration, based on the current height of the wireless device being in the height range. The processor 102 may be configured to perform mobility to a target cell among one or more candidate target cells based on the evaluation. The mobility configuration may include information on the one or more candidate target cells.

For example, the mobility may include a conditional handover (CHO) and/or a Conditional PSCell Addition/Change (CPAC).

For example, the step of performing mobility to a target cell may comprise selecting or reselecting the target cell; and camping on the target cell.

For example, the information on the mobility configuration may include information on the height range to which the mobility configuration is applicable.

For example, the information on the height range may include information on a maximum height, a minimum height, and/or a height boundary.

For example, the information on the mobility configuration may include information on a candidate target cell and information on a height range in which the candidate target cell is valid for the mobility.

For example, the height range may be set for each candidate target cell or set for each group of one or more candidate target cells.

For example, the height range may be configured per cell, per frequency, and/or per Radio Access Technology (RAT).

According to some embodiments of the present disclosure, the information on the mobility configuration may include information on a first cell group of candidate target cells associated with a first height range and a second cell group of candidate target cells associated with a second height range.

Based on the current height of the wireless device being in the first height range, the processor 102 may be configured to determine whether at least one condition for a mobility is satisfied only for the first cell group. The processor 102 may be configured to perform the mobility to a cell included in the first cell group based on the at least one condition for the mobility being satisfied.

Based on the current height of the wireless device being in the first height range, the processor 102 may be configured to determine whether at least one condition for a mobility is satisfied only for the first cell group. The processor 102 may be configured to perform the mobility to a cell included in the second cell group based on the at least one condition for the mobility being satisfied.

For example, the wireless device may be a mobile device capable of vertical mobility.

For example, the processor 102 may be configured to control the transceiver 106 to be in communication with at least one of a user equipment, a network, or an autonomous vehicle other than the wireless device.

Hereinafter, a processor for a wireless device for mobility based on height in a wireless communication system, according to some embodiments of the present disclosure, will be described.

The processor may be configured to control the wireless device to receive information on a mobility configuration associated with a height range. The processor may be configured to control the wireless device to monitor a current height of the wireless device. The processor may be configured to control the wireless device to evaluate at least one condition for a mobility based on the mobility configuration, based on the current height of the wireless device being in the height range. The processor may be configured to control the wireless device to perform mobility to a target cell among one or more candidate target cells based on the evaluation. The mobility configuration may include information on the one or more candidate target cells.

For example, the mobility may include a conditional handover (CHO) and/or a Conditional PSCell Addition/Change (CPAC).

For example, the step of performing mobility to a target cell may comprise selecting or reselecting the target cell; and camping on the target cell.

For example, the information on the mobility configuration may include information on the height range to which the mobility configuration is applicable.

For example, the information on the height range may include information on a maximum height, a minimum height, and/or a height boundary.

For example, the information on the mobility configuration may include information on a candidate target cell and information on a height range in which the candidate target cell is valid for the mobility.

For example, the height range may be set for each candidate target cell or set for each group of one or more candidate target cells.

For example, the height range may be configured per cell, per frequency, and/or per Radio Access Technology (RAT).

According to some embodiments of the present disclosure, the information on the mobility configuration may include information on a first cell group of candidate target cells associated with a first height range and a second cell group of candidate target cells associated with a second height range.

Based on the current height of the wireless device being in the first height range, the processor may be configured to control the wireless device to determine whether at least one condition for a mobility is satisfied only for the first cell group. The processor may be configured to control the wireless device to perform the mobility to a cell included in the first cell group based on the at least one condition for the mobility being satisfied.

Based on the current height of the wireless device being in the first height range, the processor may be configured to control the wireless device to determine whether at least one condition for a mobility is satisfied only for the first cell group. The processor may be configured to control the wireless device to perform the mobility to a cell included in the second cell group based on the at least one condition for the mobility being satisfied.

For example, the wireless device may be a mobile device capable of vertical mobility.

For example, the processor may be configured to control the wireless device to be in communication with at least one of a user equipment, a network, or an autonomous vehicle other than the wireless device.

Hereinafter, a non-transitory computer-readable medium has stored thereon a plurality of instructions for mobility based on height in a wireless communication system, according to some embodiments of the present disclosure, will be described.

According to some embodiment of the present disclosure, the technical features of the present disclosure could be embodied directly in hardware, in a software executed by a processor, or in a combination of the two. For example, a method performed by a wireless device in a wireless communication may be implemented in hardware, software, firmware, or any combination thereof. For example, a software may reside in RAM memory, flash memory, ROM memory, EPROM memory, EEPROM memory, registers, hard disk, a removable disk, a CD-ROM, or any other storage medium.

Some example of storage medium is coupled to the processor such that the processor can read information from the storage medium. In the alternative, the storage medium may be integral to the processor. The processor and the storage medium may reside in an ASIC. For other example, the processor and the storage medium may reside as discrete components.

The computer-readable medium may include a tangible and non-transitory computer-readable storage medium.

For example, non-transitory computer-readable media may include random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, or any other medium that can be used to store instructions or data structures. Non-transitory computer-readable media may also include combinations of the above.

In addition, the method described herein may be realized at least in part by a computer-readable communication medium that carries or communicates code in the form of instructions or data structures and that can be accessed, read, and/or executed by a computer.

According to some embodiment of the present disclosure, a non-transitory computer-readable medium has stored thereon a plurality of instructions. The stored a plurality of instructions may be executed by a processor of a wireless device.

The stored a plurality of instructions may cause the wireless device to receive information on a mobility configuration associated with a height range. The stored a plurality of instructions may cause the wireless device to monitor a current height of the wireless device. The stored a plurality of instructions may cause the wireless device to evaluate at least one condition for a mobility based on the mobility configuration, based on the current height of the wireless device being in the height range. The stored a plurality of instructions may cause the wireless device to perform mobility to a target cell among one or more candidate target cells based on the evaluation. The mobility configuration may include information on the one or more candidate target cells.

For example, the mobility may include a conditional handover (CHO) and/or a Conditional PSCell Addition/Change (CPAC).

For example, the step of performing mobility to a target cell may comprise selecting or reselecting the target cell; and camping on the target cell.

For example, the information on the mobility configuration may include information on the height range to which the mobility configuration is applicable.

For example, the information on the height range may include information on a maximum height, a minimum height, and/or a height boundary.

For example, the information on the mobility configuration may include information on a candidate target cell and information on a height range in which the candidate target cell is valid for the mobility.

For example, the height range may be set for each candidate target cell or set for each group of one or more candidate target cells.

For example, the height range may be configured per cell, per frequency, and/or per Radio Access Technology (RAT).

According to some embodiments of the present disclosure, the information on the mobility configuration may include information on a first cell group of candidate target cells associated with a first height range and a second cell group of candidate target cells associated with a second height range.

Based on the current height of the wireless device being in the first height range, the stored a plurality of instructions may cause the wireless device to determine whether at least one condition for a mobility is satisfied only for the first cell group. The stored a plurality of instructions may cause the wireless device to perform the mobility to a cell included in the first cell group based on the at least one condition for the mobility being satisfied.

Based on the current height of the wireless device being in the first height range, the stored a plurality of instructions may cause the wireless device to determine whether at least one condition for a mobility is satisfied only for the first cell group. The stored a plurality of instructions may cause the wireless device to perform the mobility to a cell included in the second cell group based on the at least one condition for the mobility being satisfied.

For example, the wireless device may be a mobile device capable of vertical mobility.

For example, the stored a plurality of instructions may cause the wireless device to be in communication with at least one of a user equipment, a network, or an autonomous vehicle other than the wireless device.

Hereinafter, a method performed by a base station (BS) for mobility based on height in a wireless communication system, according to some embodiments of the present disclosure, will be described.

The BS may provide, to a wireless device, information on a mobility configuration associated with a height range. The mobility configuration may include information on the one or more candidate target cells. The information on the mobility configuration may include information on the height range to which the mobility configuration is applicable.

Hereinafter, a base station (BS) for mobility based on height in a wireless communication system, according to some embodiments of the present disclosure, will be described.

The BS may include a transceiver, a memory, and a processor operatively coupled to the transceiver and the memory.

The processor may be configured to control the transceiver to provide, to a wireless device, information on a mobility configuration associated with a height range. The mobility configuration may include information on the one or more candidate target cells. The information on the mobility configuration may include information on the height range to which the mobility configuration is applicable.

The present disclosure can have various advantageous effects.

According to some embodiments of the present disclosure, a wireless device could efficiently perform conditional mobility based on the height-based mobility configuration.

For example, depending on its altitude, the UE may perform a reselection of or execute conditional mobility to a suitable cell, such as a UAV-specific cell or a nearby cell.

In other words, the UE may reselect or execute conditional mobility to a suitable cell, such as a UAV specific cell or a nearby cell, according to the height.

For example, by applying candidate target cells based on the height of the wireless device, it can perform efficient mobility such as CHO and/or CPAC.

For example, a wireless device could save resources by preventing mobility to unsuitable cells.

According to some embodiments of the present disclosure, a wireless network system could provide an efficient solution for the height-based mobility.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1-34. (canceled)

35. A method, comprising:
receiving, by a wireless device, information on a mobility configuration associated with a height range;
monitoring, by the wireless device, a current height of the wireless device;
evaluating, by the wireless device, at least one condition for a mobility based on the mobility configuration, based on the current height of the wireless device being in the height range; and
performing, by the wireless device, mobility to a target cell among one or more candidate target cells based on the evaluation,
wherein the mobility configuration includes information on the one or more candidate target cells.

36. The method of claim 35,
wherein the mobility includes a conditional handover (CHO) and/or a Conditional PSCell Addition/Change (CPAC).

37. The method of claim 35, wherein the step of performing mobility to a target cell comprises,
selecting or reselecting, by the wireless device, the target cell; and
camping, by the wireless device, on the target cell.

38. The method of claim 35,
wherein the information on the mobility configuration includes information on the height range to which the mobility configuration is applicable.

39. The method of claim 38,
wherein the information on the height range includes information on a maximum height, a minimum height, and/or a height boundary.

40. The method of claim 35,
wherein the information on the mobility configuration includes information on a candidate target cell and information on a height range in which the candidate target cell is valid for the mobility.

41. The method of claim 35,
wherein the height range is set for each candidate target cell or set for each group of one or more candidate target cells.

42. The method of claim 35,
wherein the height range is configured per cell, per frequency, and/or per Radio Access Technology (RAT).

43. The method of claim 35,
wherein the information on the mobility configuration includes information on a first cell group of candidate target cells associated with a first height range and a second cell group of candidate target cells associated with a second height range.

44. The method of claim 43, wherein the method further comprises,
based on the current height of the wireless device being in the first height range, determining, by the wireless device, whether at least one condition for a mobility is satisfied only for the first cell group.

45. The method of claim 44, wherein the method further comprises,
performing, by the wireless device, the mobility to a cell included in the first cell group based on the at least one condition for the mobility being satisfied.

46. The method of claim 43, wherein the method further comprises,
based on the current height of the wireless device being in the first height range, determining, by the wireless device, whether at least one condition for a mobility is satisfied only for the first cell group.

47. The method of claim 46, wherein the method further comprises,
performing, by the wireless device, the mobility to a cell included in the second cell group based on the at least one condition for the mobility being satisfied.

48. The method of claim 35,
wherein the wireless device is a mobile device capable of vertical mobility.

49. The method of claim 35,
wherein the wireless device is in communication with at least one of a user equipment, a network, or an autonomous vehicle other than the wireless device.

50. A wireless device, comprising:
a transceiver;
a memory; and
at least one processor operatively coupled to the transceiver and the memory, and adapted to:
control the transceiver to receive information on a mobility configuration associated with a height range;
monitor a current height of the wireless device;
evaluate at least one condition for a mobility based on the mobility configuration, based on the current height of the wireless device being in the height range; and
perform mobility to a target cell among one or more candidate target cells based on the evaluation,
wherein the mobility configuration includes information on the one or more candidate target cells.

51. The wireless device of claim 50,
wherein the mobility includes a conditional handover (CHO) and/or a Conditional PSCell Addition/Change (CPAC).

52. The wireless device of claim 50, wherein the step of performing mobility to a target cell comprises,
selecting or reselecting the target cell; and
camping on the target cell.

53. The wireless device of claim 50,
wherein the information on the mobility configuration includes information on the height range to which the mobility configuration is applicable.

54. A base station in a wireless communication system comprising:
a transceiver;
a memory; and
a processor operatively coupled to the transceiver and the memory, and adapted to:
provide, to a wireless device, information on a mobility configuration associated with a height range,
wherein the mobility configuration includes information on the one or more candidate target cells, and
wherein the information on the mobility configuration includes information on the height range to which the mobility configuration is applicable.
